(19) United States
(12) Patent Application Publication
(10) Pub. No.: US 2026/0135801 A1
(43) Pub. Date: May 14, 2026

(54) SEMANTIC ROUTING INFERENCE SYSTEMS, METHODS, AND APPARATUSES

(71) Applicant: Beyond AGI LLC, Austin, TX (US)

(72) Inventors: Pavel Jacko, Westbeemster (NL); Marko Lehtimäki, Hyllykallio (FI); Harri S. Sarsa, Berlin (DE)

(21) Appl. No.: 19/386,322

(22) Filed: Nov. 12, 2025

Related U.S. Application Data
(60) Provisional application No. 63/719,196, filed on Nov. 12, 2024.
(60) Provisional application No. 63/723,572, filed on Nov. 21, 2024.

(51) Int. Cl. H04L 45/24; H04L 45/00; H04L 45/02

(52) U.S. Cl. CPC H04L 45/24; H04L 45/02; H04L 45/22

(57) ABSTRACT

The present disclosure sets forth systems, apparatuses, and methods that intelligently route data through a network. One method involves receiving data, determining, based on comparing an aspect of the data to metadata associated with the at least two other nodes, a probability distribution indicating routing probabilities. Based on determining that at least one of the at least two other nodes is associated with a routing probability greater than a threshold, routing the data to the at least one of the at least two other nodes. Based on the determining that the at least two other nodes are not associated with probabilities greater than the threshold, the method determines contextual information and transformed network structure, and based on that, the data is routed to a first node of the at least two other nodes.

### CROSS REFERENCE TO RELATED APPLICATIONS

This patent claims priority to and the benefit of U.S. Provisional Patent Application No. 63/719,196, filed on Nov. 12, 2024, entitled “Semantic Routing Inference Engine,” and U.S. Provisional Patent Application No. 63/723,572, filed on Nov. 21, 2024, entitled “Semantic Routing Inference Engine.” U.S. Provisional Patent Application No. 63/719,196 and U.S. Provisional Patent Application No. 63/723,572 are hereby incorporated herein by reference in their entireties.

### FIELD OF THE DISCLOSURE

This disclosure relates generally to semantic routing inference systems, methods, and apparatuses for optimizing routing decisions in (complex) networks, including but not limited to distributed computing systems, microservices architectures, content delivery networks, Internet of Things networks, autonomous agent networks, artificial intelligence systems, and neural networks.

### BACKGROUND

Networks often face routing challenges in dynamic environments where topology, context, and node capabilities may change unpredictably. Traditional routing approaches usually rely on static configurations or reactive protocols that struggle to optimize routing decisions in complex networks with non-deterministic elements.

### BRIEF DESCRIPTION OF THE DRAWINGS

FIG. 1 is a perspective view of an example network architecture in accordance with teachings of this disclosure.

FIG. 2 is a perspective view of an example network topology showing nodes and connections in accordance with teachings of this disclosure.

FIG. 3 is a block diagram of an example machine learning based routing in accordance with teachings of this disclosure.

FIG. 4 is a block diagram of an example semantic routing inference engine in accordance with teachings of this disclosure.

FIG. 5 is a flow chart illustrating an optimization implementation in accordance with teachings of this disclosure.

FIG. 6 is a timing diagram of an implementation of the example semantic routing inference engine of FIG. 4 in accordance with teachings of this disclosure.

FIG. 7 is a flow chart illustrating an implementation of an inference engine in accordance with teachings of this disclosure.

FIG. 8 is a flow diagram of an example network of nodes and sub-nodes in accordance with teachings of this disclosure.

FIG. 9 is a flow diagram of an example simplified network in accordance with teachings of this disclosure.

FIG. 10 is a flow diagram of an example first node subnetwork in accordance with teachings of this disclosure.

FIG. 11 is a flow diagram of an example second node subnetwork in accordance with teachings of this disclosure.

FIG. 12 is a flow diagram of an example third node subnetwork in accordance with teachings of this disclosure.

FIGS. 13A-13B are a flow diagram of an example support system network in accordance with teachings of this disclosure.

FIG. 14 is a block diagram illustrating an example integration interface in accordance with teachings of this disclosure.

FIG. 15 is a block diagram illustrating a performance monitoring implementation in accordance with teachings of this disclosure.

FIG. 16 is a block diagram illustrating a fault tolerance implementation in accordance with teachings of this disclosure.

FIG. 17 is a flow chart illustrating another fault tolerance implementation in accordance with teachings of this disclosure.

FIG. 18 is a block diagram of a computing device used in accordance with the teachings of this disclosure.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

The present disclosure relates to systems, methods, and apparatuses for intelligently routing data through networks using semantic inference and probability-based decision making. Networks often face routing challenges in dynamic environments where topology, context, and node capabilities may change unpredictably. Traditional routing approaches usually rely on static configurations or reactive protocols that struggle to optimize routing decisions in complex networks with non-deterministic elements. The systems, methods, and apparatuses described herein address these routing challenges through semantic understanding of network topology, contextual analysis of routing requests, and inference-based decision making that considers both immediate and downstream routing effects.

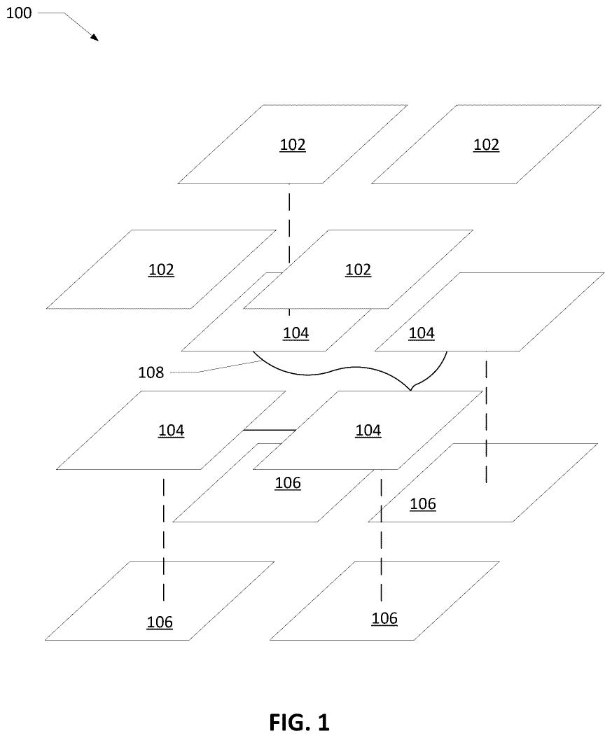

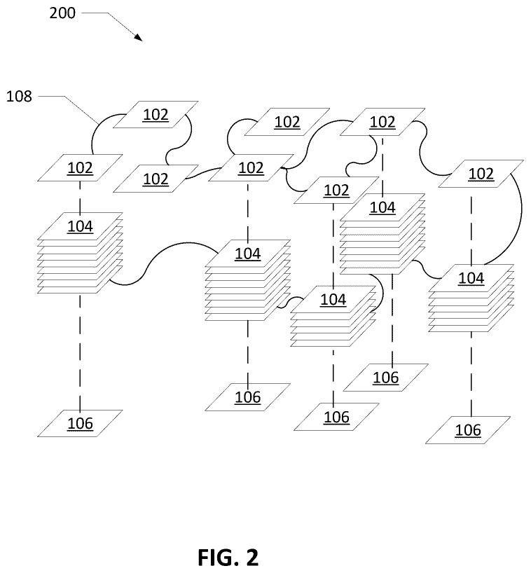

FIGS. 1-2 illustrate example network architectures in which the semantic routing inference systems, methods, and apparatuses described herein may be implemented. The example networks may comprise a plurality of nodes 102, 104, 106 interconnected by connections 108, where nodes may be implemented via software modules, hardware components, or combinations thereof. In some examples, nodes may be deployed on devices, systems, local area networks, cloud-based networks, Internet-based networks, or any combination thereof. The disclosed semantic routing techniques apply regardless of the specific network architecture, node implementation, or deployment configuration. In some examples, nodes may be associated with large language models and may be generated, adapted, modified, or eliminated dynamically in real time to constantly adapt to ever-changing inputs. The ever-changing number of nodes and the connections therebetween may produce different outputs for a same given input, enabling non-deterministic behavior.

Modern networks—whether deployed as cloud microservices, Internet of Things (IoT) systems, content delivery networks, autonomous agent systems, or neural networks—face unprecedented routing challenges. These networks are characterized by constantly changing topologies, where nodes and connections may frequently change due to mobility, failures, reconfigurations, or dynamic scaling in response to real-time demand. The contextual relevance and priority of data may shift based on temporal factors, user demands, or unforeseen circumstances. Not all nodes produce deterministic outputs; many produce outputs that are unstructured or probabilistic, making it difficult to predict subsequent states or codify algorithmic routing rules. Furthermore, data packets may not follow predefined formats, and autonomous agents with independent goals may introduce emergent behaviors that are difficult to model and anticipate. Such factors may contribute to an environment where optimal routing decisions may not be fully pre-coded, but may have to adapt to real-time conditions and behaviors that may not be fully anticipated.

The systems, methods, and apparatuses described herein address these routing challenges through semantic understanding and inference-based decision making. The disclosed systems may be applied to any network comprising nodes and connections, regardless of whether the network is static or dynamic, whether nodes are physical devices or virtual instances, and whether the network topology is fixed or ever-changing. In some examples, the network may comprise a generative neural network where nodes and connections are dynamically created, modified, or removed. In some examples, the network may comprise a static topology with complex interconnections. In some examples, the network may comprise microservices that scale dynamically. In some examples, the network may comprise IoT devices with varying capabilities. In some examples, the network may comprise content delivery servers distributed geographically. In some examples, the network may comprise autonomous agents with independent goals. The routing inference techniques described herein apply regardless of the specific network type or implementation.

To better understand the scope and applicability of the disclosed systems, methods, and apparatuses, the following paragraphs provide detailed examples of various modern network architectures that present routing challenges, followed by an analysis of traditional routing approaches and their limitations, and finally a comprehensive description of how the disclosed semantic routing inference engine overcomes these limitations.

Modern networks, including dynamic networks, may be characterized by constant changes that affect routing decisions in real time. These changes may stem from various factors such as evolving network topology, changing context, non-deterministic outputs, unstructured data flow, and multi-agent interactions. For example, the nodes and connections within a network may frequently change due to mobility, failures, or reconfigurations, often driven by internal algorithms or external events. The contextual relevance and priority of data may shift based on temporal factors, user demands, or unforeseen circumstances. Not all queries may be deterministic and nodes in a network addressing such queries may produce outputs that are unstructured or probabilistic, which may make it difficult to predict subsequent states or codify algorithmic routing rules. Furthermore, data packets may not follow predefined formats, which may add complexity to routing decisions. And, autonomous agents with independent goals may introduce emergent behaviors that are difficult to model and anticipate. Such factors may contribute to an environment where optimal routing decisions may not be codable, but may depend on real-time conditions and behaviors that cannot be fully anticipated.

For example, in a cloud-native microservices architecture, which may involve intricate ecosystems of interconnected microservices, services may dynamically scale up or down in response to real-time demand, and new instances can be created or terminated at any moment. Service discovery may become a moving target as the network topology changes constantly. As containers and services are created or destroyed, routing mechanisms may have to adapt instantly. Load fluctuations may require services to scale automatically, affecting routing paths. Multiple versions of a service may run concurrently, complicating compatibility and routing. Complex webs of inter-service communication may demand routing decisions that consider multiple hops and dependencies. Maintaining strict latency requirements may be challenging as the underlying topology changes. The systems, methods, and apparatuses disclosed herein can understand the context and dependencies between services and adapt routing decisions in real time. Traditional routing systems lack such capability.

As another example, Internet of Things (IoT) networks may comprise a diverse range of devices, from powerful edge computers to tiny sensors with limited resources. The network conditions can vary dramatically due to device mobility, interference, or environmental factors. Devices with vastly different capabilities may require adaptable routing strategies. Changing network conditions may demand real-time adjustments in routing. Data that may be low priority in one context may become critical in another. Limited battery life and processing power may necessitate efficient routing to conserve resources. Routing in IoT networks may require an understanding of context and the ability to prioritize data dynamically.

Content Delivery Networks (CDNs) distribute content to users worldwide, requiring routing decisions that balance factors like geographic location, server load, and network congestion. CDNs face many challenges such as directing users to the nearest server while accounting for real-time network conditions and efficient handling of both popular and niche content across different cache layers. Rapid shifts in what content is popular may require agile cache management and routing. Maintaining performance despite unexpected issues may demand robust routing strategies. The systems, methods, and apparatuses disclosed herein consider a global view of the network and adapt to real-time changes.

Autonomous Vehicle Networks, also known as connected vehicles, must communicate constantly (e.g., sharing data for navigation and safety) in environments where network coverage and conditions vary. Ultra-reliable, low-latency communication may be needed for immediate and dependable delivery of safety-critical messages. Because vehicle groups form and dissolve as a part of traffic, flexible routing may be required. Sudden spikes in data transmission may need instant routing adjustments. High-density communication environments may demand precise coordination. The systems, methods, and apparatuses disclosed herein can handle such dynamic and critical routing decisions by reasoning about context and adapting instantly-beyond the capabilities of traditional routing protocols.

Financial trading systems may operate in environments where milliseconds matter, processing vast amounts of data while executing trades. Routing decisions may emphasize minimization of delays to maintain a competitive edge. Ensuring reliable message delivery, compliance, and maintaining audit trails may add complexity. Rapid changes may demand immediate adjustments in routing and resource allocation. Balancing latency, reliability, and compliance may require sophisticated routing logic. The systems, methods, and apparatuses disclosed herein handle competing priorities and adapt to rapid changes.

Smart city infrastructure comprising various systems—traffic management, utilities, public safety—may require coordination and real-time data sharing. Diverse systems may need to communicate and make joint decisions, handle and route large volumes of sensor data efficiently, ensure that important data reaches decision-makers promptly, and adjust to events like accidents or weather changes in real time.

Autonomous robotics operate in environments like warehouses or manufacturing plants and communicate within constantly changing settings. Physical environmental changes (e.g., rearrangement of objects, moving humans, moving equipment, etc.) may require robots to adjust routing and navigation on the fly. Sudden changes in task importance may demand immediate routing adjustments. Where multiple robots operate in a same environment, efficient communication and collaboration among robots may be required. The systems, methods, and apparatuses disclosed herein provide adaptive, context-aware routing that can handle sudden changes.

Networks of AI agents may interact in complex ways. In some examples, communication patterns may evolve as agents learn and adapt. Unpredictable behaviors may make routing difficult to model. New communication patterns can arise, which may require routing strategies to adapt. Agents' goals may change, which may alter the importance of certain data flows. Managing a large number of intelligent agents may overwhelm a network. The systems, methods, and apparatuses disclosed herein handle non-deterministic outputs and emergent behaviors by semantically reasoning about a network.

Traditional routing methods fall short in addressing the complexities of modern dynamic networks. Algorithms like Dijkstra's or A* calculate optimal paths based on static network topologies. Assuming a static topology may lead to the inability to adapt to changes in the network, outputting outdated or invalid paths. Pre-computed paths may not be able to adjust to real-time conditions. For example, in a manufacturing facility with automated guided vehicles (AGVs), pre-calculated paths can become obsolete due to temporary obstacles or layout changes, causing inefficiencies or deadlocks.

It may also be computationally infeasible to calculate all paths in large, dynamic networks. In networks having 1-3 nodes, routing may be relatively simple (e.g., a choice between two paths). In some such examples, the different paths may be determined based on the differences in the capabilities of the nodes. For example, if one of the nodes is associated with calculation functionality and another node is associated with providing written query responses, selecting between these nodes may be relatively simple (e.g., choose the calculation node for math-based queries and choose the written response node for linguistic-based queries). However, when the node count grows to the hundreds, thousands, tens of thousands, etc., routing becomes increasingly complicated. Even if feasible, routing decisions would be based on predefined conditions or rules set by human operators. For example, even with hundreds, thousands, tens of thousands of nodes, various routing paths could be pre-programmed (although such deterministic programming would take significant time and resources). But decisions made without considering the broader network state (which is constantly changing) can lead to suboptimal routing. Hard coded networks may be unable to handle nuanced or unexpected situations beyond the predefined rules. Complex network interactions can produce states not anticipated by the rules. For example, a CDN that routes traffic based on server load thresholds may fail to optimize for rapidly changing conditions or failover scenarios.

Some adaptive routing protocols attempt to adjust routes dynamically based on network conditions. But, frequent route updates can consume significant resources and introduce delays. And, these systems often respond to changes after they occur, rather than anticipating them. In some examples, these adaptive protocols introduce additional layers of complexity without fully addressing dynamic challenges. For example, in a mesh network of IoT devices, adaptive protocols may struggle with rapid topology changes, leading to congestion or routing loops.

Modern dynamic routing protocols like Open Shortest Path First (OSPF), Enhanced Interior Gateway Routing Protocol (EIGRP), and Border Gateway Protocol (BGP) demonstrate significant capabilities in handling network changes. Dynamic routing protocols may be capable of real-time topology updates through neighbor discovery, fast convergence after network changes, load balancing across multiple paths, and support for hierarchical network structures.

But, dynamic routing protocols may have limited semantic understanding of traffic patterns, may be reactive rather than predictive of adaptations, may have protocol-specific constraints on routing decisions, and may have difficulty handling non-deterministic network elements. For example, while OSPF can quickly adapt to link failures, it may be unable to anticipate congestion based on semantic understanding of application behavior or optimize routes based on predicted future states. Dynamic routing protocols may also not be able to handle non-deterministic network elements in a holistic manner.

Recent developments have led to the use of machine learning models to predict optimal routing paths. But machine learning is highly dependent on training data. Machine learning models may not generalize well to unseen or rapidly changing conditions, may require intensive resources for real-time inference, unsuitable for devices with limited capabilities. Learned policies may become obsolete quickly in dynamic networks. For example, a reinforcement learning model for routing in a CDN may not adapt quickly enough to sudden spikes in content popularity or network congestion.

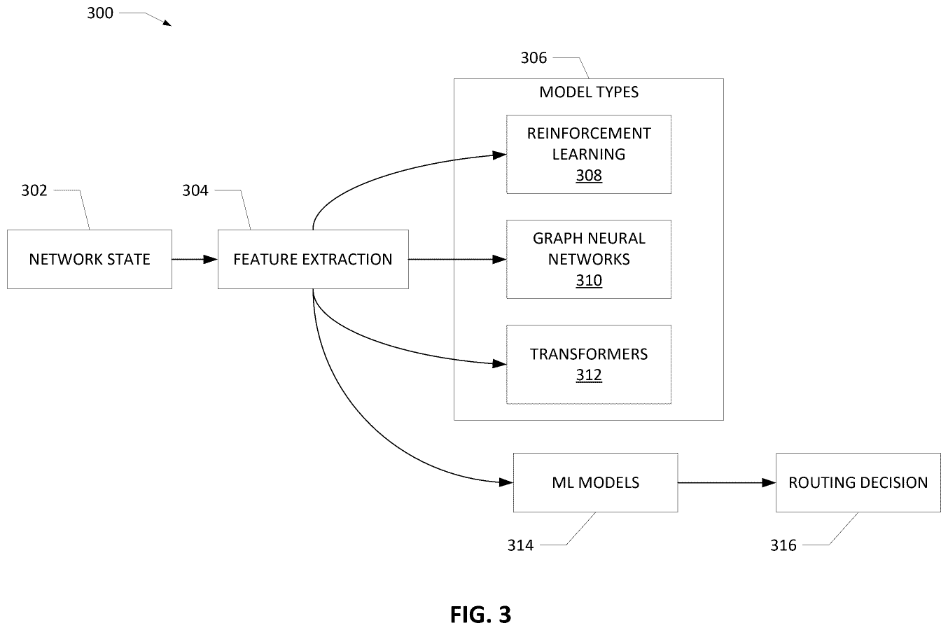

FIG. 3 illustrates a model-based routing system 300. The model-based routing system 300 may determine the state of a network with a network state module 302. A feature extraction module 304 may extract various features from the state of the network determined by the network state module 302. The feature extraction module 304 can send the various features to a plurality of model types 306.

For example, a first model type may be a reinforcement learning (RL) model 308. The reinforcement learning model 308 may implement an adaptive policy learning through real-world network interactions, may implement real-time optimization based on feedback loops, may improve through experience via reward signals, may dynamically adjust routing policies, may handle changing network conditions, may be capable of multi-objective optimization, and may learn from historical routing decisions. For example, an RL-based router in a CDN may learn to predict and route around congestion points before they become critical bottlenecks.

A second model type may be a graph neural network (GNN) model 310. The GNN model 310 may perform topology-aware processing of network structures, may preserve structure across transformations, may scale to large and complex networks, may pass messages between network nodes, may perform hierarchical representation learning, may efficiently handle sparse connectivity, and may integrate node and edge features. For example, GNNs may be used to optimize routing in a microservices architecture by understanding service dependencies and communication patterns.

A third model type may be a transformer model 312. The transformer model 312 may make sequential decisions with attention mechanisms, may process long-range dependencies in network flows, may integrate rich context across multiple hops, may process routing requests in parallel, assess priority, may transfer learning capabilities, and may handle variable-length routing sequences. For example, a transformer-based router may analyze packet flows in an IoT network to identify and prioritize critical sensor data.

However, these approaches face challenges such as high training data requirements for accurate modeling, difficulty with zero-shot scenarios and novel network states, limited explainability of routing decisions, intensive resource usage in both training and inference, large latency overhead for complex models, difficulty in maintaining consistent performance, difficulty adapting to new patterns in real-time, balancing exploration vs. exploitation in learning, and integration complexity with existing infrastructure.

Combining multiple models together for routing methodologies may leverage their respective strengths while mitigating their individual weaknesses. For example, a hybrid of the above models may enable flexible routing based on request complexity, efficient resource utilization through tiered processing, balanced performance and decision quality, and integration of multiple routing paradigms. However, hybrid models may be subject to increased system complexity, challenges in maintaining consistency across approaches, higher maintenance overhead, and the potential for conflicting decisions between methods. For example, a hybrid router might use traditional routing for simple point-to-point communication, ML-based routing for known traffic patterns, and semantic reasoning for complex, context-dependent scenarios.

The feature extraction module 304 may, additionally or alternatively, forward network state features to machine learning (ML) models 314 (such as Large Language Models) to come to a routing decision 316. In some examples, the ML models 314 may utilize large language models (LLMs) to interpret queries and generate routing decisions. But ML models 314 often consider only immediate information, ignoring downstream consequences. The variability in LLM responses can introduce unpredictability in routing. Processing queries with LLMs can be resource-intensive and may not meet real-time requirements. For example, in an AI agent network, an LLM-based router may not effectively coordinate complex tasks that require considering the entire network state.

In summary, traditional routing methodologies face significant challenges with dynamic networks. Current approaches struggle to adapt to real-time changes, handle non-deterministic outputs, and consider global network context. The systems, methods, and apparatuses described herein overcome the limitations of prior routing systems through several key capabilities. First, these systems perform semantic understanding that leverages deep language comprehension to interpret complex routing requirements and context, going beyond simple pattern matching. Second, they analyze networks holistically by considering the entire network topology and downstream effects of routing decisions rather than just immediate metrics or local optimizations. Third, they dynamically adjust routing strategies based on real-time network conditions, historical patterns, and predicted future states. Fourth, they process unstructured data and non-deterministic outputs through semantic analysis, enabling intelligent handling of ambiguous scenarios. Fifth, they seamlessly incorporate various AI models and traditional routing systems, allowing for hybrid approaches that maximize effectiveness. Sixth, they provide clear reasoning for routing choices, enabling validation and trust in critical applications. The systems, methods, and apparatuses described herein provide an alternative approach that may combine adaptive routing with semantic analysis. The systems, methods, and apparatuses described herein may use context-aware decision making and probabilistic methods to handle unpredictable network conditions while maintaining consistent performance.

The systems, methods, and apparatuses described herein consider the entire network topology and any changes thereto to determine which subsequent node(s) to route a query through the network. As an example, a network node having 10 or more connections can forward data to all connecting nodes to route data through the network. This, however, may be inefficient as a number of the subsequent nodes may not need to receive the data for successful routing through the network. Additionally, if every node invokes an inference process, and if each node forwards data to 10 or more subsequent nodes, the processing of a signal through such a network (e.g., 1000 nodes) would take a significant amount of time (e.g., hours rather than minutes or seconds).

Alternatively, a network node may analyze each of the connecting nodes before routing data a subsequent node. Such analysis may be complex, conditional, and resource intensive. As networks expand in complexity (e.g., as new nodes/connections are added), the complexity, conditions, and required resources increase. While each route could potentially be hard coded, every time a network topology changes (e.g., nodes/connections are established/added/removed/ignored/adjusted), additional hard coding would be necessary (and subsequent updates issued to take advantage of established/added/removed/ignored/adjusted nodes/connections).

The systems, methods, and apparatuses described herein work with any network architecture, including networks where the nodes and the connections between the nodes may be ever changing (e.g., nodes and/or connections between nodes may be established, added, modified, ignored, adjusted, or removed) and networks with static topologies. The systems, methods, and apparatuses described herein make routing decisions (such as determining the most optimized path, the shortest path, the path that produces the most correct result, etc.) regardless of whether the nodes, connections between the nodes, and thus the possible paths through the network are static or dynamic.

Because there may be varying conditions that would lead to routing data to one or more nodes over others, it may be practically impossible to know the best possible routing decision to a given query, particularly in large-scale networks with hundreds or thousands of nodes and complex interconnections. In order to achieve the optimal routing decisions without exhaustively analyzing every possible path, the systems, methods, and apparatuses disclosed herein make inferences on possible routing paths based on available data approximating the most viable option. Specifically, the systems, methods, and apparatuses disclosed herein run hypothetical routing scenarios separately from receipt of a given query. For example, the systems, methods, and apparatuses disclosed herein may run these hypothetical routing scenarios whenever the network has excess resources. The systems, methods, and apparatuses disclosed herein may perform the hypothetical routing scenarios before receiving any query, after receiving one or more first queries but before receiving one or more second queries, after receiving a threshold amount of third queries in a first period of time, etc. The example systems, methods, and apparatuses disclosed herein may preempt a given query and test out various pathways through the network in advance of receiving a subsequent query, such that the systems, methods, and apparatuses disclosed herein can pre-process potential routes for the subsequent query and determine the best route for the subsequent query in an efficient manner when the subsequent query is received. In some examples, the systems, methods, and apparatuses disclosed herein may create variations of a given query during its hypothetical routing scenarios to test out not only the various paths that a given query may traverse within the network, but also variations to the input that would therefore result in various different paths that the variation of the query may traverse within the network.

To begin, the systems, methods, and apparatuses disclosed herein may determine natural language representations of each node within a network. In some examples, the natural language representations may describe an individual node's capabilities and/or objectives. For example, one node may be configured for mathematical calculations, another node may be configured for chemical analysis, another node may be configured for linguistics, etc. When incoming data arrives at a given node, the systems, methods, and apparatuses disclosed herein may compare the natural language representation of the incoming data with the natural language representations of subsequent nodes of the network to determine a probability distribution indicating probabilities of success in routing the given data. In some examples, if the probabilities of success for subsequent nodes exceed a threshold (e.g., 0.50 or 50%), then the systems, methods, and apparatuses disclosed herein may route the incoming data to those subsequent nodes (and not route the incoming data to subsequent nodes whose probabilities of success fail to exceed the threshold). In some examples, the threshold may be configurable to increase or decrease the number of potential routes.

In some examples, when there are multiple subsequent nodes whose probabilities of success exceed the threshold, the incoming data may be routed to those nodes equally (e.g., split the data signal strength evenly across all such nodes). In some such examples, weighting the data signals equally may provide each probable route the best chance of success. In other examples when there are multiple subsequent nodes whose probabilities of success exceed the threshold, the incoming data may be routed to those nodes according to the probabilities of success (e.g., weight the signal strength of the data routed to a node having a probability of success of 70% at 0.70, weight the signal strength of the data routed to a node having a probability of success of 51% at 0.51, etc.). In some such examples, weighting the data signals according to the probabilities of success of the subsequent nodes may further strengthen higher probability routes when multiple probable routes exist.

In some examples, the natural language representation of the nodes may not be sufficient for a routing determination. For example, although a natural language representation of one node may indicate a higher probability of success over another node, the other node may ultimately be the better routing option. Additionally, other factors such as context, network topology, processing resources, bandwidth, etc. may impact routing decisions. The systems, methods, and apparatuses disclosed herein, therefore, update the probability distributions for subsequent nodes according to actual or hypothetical routing of data through the network For example, as the systems, methods, and apparatuses disclosed herein route data through the various pathways of the network, certain pathways may arrive at relevant endpoint (e.g., one that provides a relatively correct result), whereas other pathways may terminate early, or arrive at an irrelevant endpoint (e.g., one that provides a relatively incorrect result). In some examples, the systems, methods, and apparatuses disclosed herein may weight the pathways that arrive at relevant endpoints incrementally higher than the other pathways. In some examples, the systems, methods, and apparatuses disclosed herein may weight the pathways that arrive at an irrelevant endpoint or terminate early lower than the other pathways. In some examples, the systems, methods, and apparatuses disclosed herein may weight the pathways that arrive at an irrelevant endpoint incrementally higher than the pathways that terminate early. In some examples, the systems, methods, and apparatuses disclosed herein may weight the pathways that arrive at an irrelevant endpoint similarly to the pathways that terminate early.

Over time, the systems, methods, and apparatuses disclosed herein may update the probability distributions based on the weighting of the pathways through the network. In some examples, the systems, methods, and apparatuses disclosed herein may update natural language representations of the nodes to reflect the updated weighting for a given query (and variations of that query). Therefore, at the node level, routing decisions for subsequent data may be probabilistically pre-determined such that when data arrives at a given node, the subsequent node(s) may be essentially already determined according to the node probability distribution.

In some examples, the probability distributions for subsequent nodes may be formed and updated as part of a schema. In some such examples, the schema may enable efficient decisions based on the probability distributions. For example, rather than utilizing an entire large language model, the schema may limit processing to merely making an inference based on the probability distributions such that the determination may be made a quickly as possible (much like pulling data from cache storage). In some examples, the systems, methods, and apparatuses disclosed herein may store different node probability distributions in various different types of ways, regardless of the speed of accessibility. In some examples, the different node probability distributions may be stored in a cache storage dedicated to each node for quick retrieval. In some examples, the different node probability distributions may be stored in such a way that the data may be accessed as fast as possible. For example, the different node probability distributions may be stored in hash indexed databases, random access memory (RAM), solid state drives (SSDs), or the like.

In some such examples, when information that is similar or a variation of the query arrives at a node, the subsequent node(s) to which that information should go may have been already determined. For example, if a path A1->B2->C3->D4 is taken within the network, the schema may comprise an association between the type of data that arrived at node A1 and the subsequent next node B2, an association between the type of data that arrived at node B2 and the subsequent next node C3, an association between the type of data that arrived at node C3 and the subsequent next node D4, and an association between the type of data that arrived at node D4 and the resulting output. In some examples, this schema may be embedded at the node level, so that each node comprises the association with the next node. Additionally or alternatively, as a signal passes through the network, each node may comprise the associations of all prior nodes as well as the subsequent next node. Using the above path A1->B2->C3->D4, node A1 may comprise an association between node A1 and node B2, node B2 may comprise an association between nodes A1->B2 and node C3, node C3 may comprise an association between nodes A1->B2->C3 and node D4, and node D4 may comprise an association between nodes A1->B2->C3->D4 and the resulting output. The associations discussed above may apply equally to all paths through the network, regardless of the number of nodes and/or dimensions within the paths.

The path(s) can be subsequently analyzed and reanalyzed (such as during downtime of the network) without executing actual routing operations. For example, if one or more paths resulted in the production of a query response, the one or more paths may be repeated and analyzed with variations of the data (e.g., variations of the query), the paths, the nodes, and the connections between nodes without producing additional query responses. For example, various related queries may be analyzed using the same path A1->B2->C3->D4; the same query may be analyzed using the same nodes, but a different path A1->B2->D4->C3; the same query may be analyzed using different nodes and thus also a different path F1->Q4->G2->H9; and any combination thereof. The metadata associated with the various nodes may be useful in such analysis.

Thus, the probability distributions may be weighted based on both actual paths routed through the network and hypothetical paths analyzed but not routed through the network. In some examples, actual paths executed may be weighted more heavily than hypothetically analyzed paths. Additionally, paths not taken may be weighted lower than paths taken actually or hypothetically. In this way, probability distributions may be created with various weights/probabilities associated with possible subsequent nodes, such that when new information comes into the network, routing determinations may be made more quickly using these weighted probability distributions. While the weights may be described herein as one-dimensional for simplicity, the weightings may also be multidimensional. In some examples, the weightings may be multidimension arrays. In some such examples, the probability distributions may expand exponentially based on the number of dimensions associated with the weightings.

The example node probability distribution may be updated in real time according to paths taken by signals in response to actual queries (e.g., reinforcement learning), or during hypothetical routing scenarios performed by the systems, methods, and apparatuses disclosed herein. In some examples, the node probability distribution may be updated constantly by the systems, methods, and apparatuses disclosed herein. The performance of the example hypothetical routing scenarios described above that result in the various node probability distributions may occur at any time. In some examples, the example hypothetical routing scenarios may occur during times of low network activity. In some examples, the example hypothetical routing scenarios may occur in parallel in the background while the network is handling other requests.

In some examples, the systems, methods, and apparatuses disclosed herein need not perform every possible hypothetical routing scenario. In some examples, the amount of hypothetical routing scenarios may be approximated to a given percentage (e.g., 60% of possible routing scenarios). In some examples, this percentage may vary in order to balance processing time with accuracy (e.g., more scenarios means slower processing but higher accuracy, less scenarios means faster processing but lower accuracy). In some examples, more scenarios may be performed during times with excess resources (e.g., middle of the night). In some examples, less scenarios may be performed during times with limited resources (e.g., during the middle of the day).

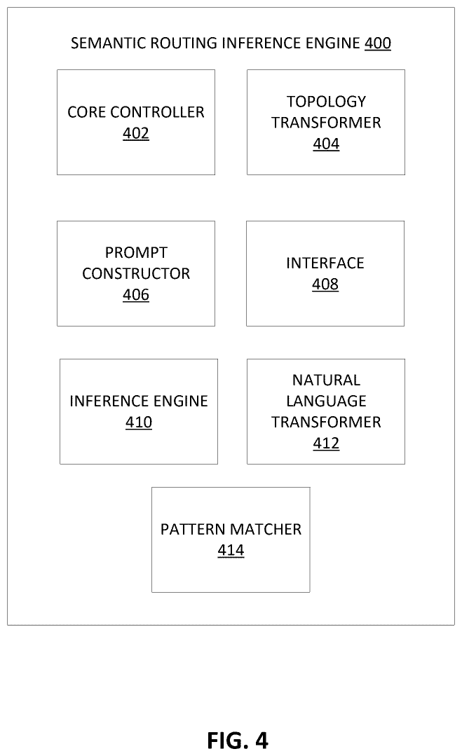

FIG. 4 illustrates an example semantic routing inference engine 400 providing the advantages and capabilities described above. The semantic routing inference engine 400 may be network-agnostic and may be deployed in any network architecture where routing decisions involve semantic understanding, contextual analysis, or evaluation of multiple potential paths. In some examples, a node of a network may comprise the example semantic routing inference engine 400. In some examples, the example semantic routing inference engine 400 may be a hardware component separate from, but connected to, the network. In some examples, the semantic routing inference engine 400 may be deployed across multiple nodes in a distributed manner. The example semantic routing inference engine 400 may perform real-time performance monitoring and anomaly detection. In some examples, the semantic routing inference engine 400 may perform automated A/B testing of routing strategies. In some examples, the semantic routing inference engine 400 may implement self-healing mechanisms for degraded routes. As further explained below, the example semantic routing inference engine 400 may continuously optimize its prompts based on success metrics. Furthermore, the semantic routing inference engine 400 may use version control and rollback capabilities for model updates and automated retraining triggers based on performance thresholds.

The semantic routing inference engine 400 may implement a three-phase operational architecture that enables efficient real-time routing decisions. In a first phase, the semantic routing inference engine 400 may process actual routing requests through the network, generating routing decisions and forwarding data through determined paths. In a second phase, which may occur in parallel with or independently from the first phase, the semantic routing inference engine 400 may perform background processing to analyze hypothetical routing scenarios. This background processing may create probability distributions and schemas that represent pre-computed routing intelligence without directly routing actual data. In a third phase, when new routing requests arrive, the semantic routing inference engine 400 may leverage the pre-computed probability distributions and schemas from the second phase to make substantially instantaneous routing decisions without invoking the full inference process for every decision point. This three-phase architecture may enable the semantic routing inference engine 400 to balance comprehensive analysis with real-time performance requirements. In some examples, the second phase may occur during periods of low network activity, during parallel background processing, or according to resource availability thresholds. The three-phase architecture may enable the semantic routing inference engine 400 to appear to predict optimal routes in real-time by having pre-analyzed potential routing scenarios through the second phase background processing.

The example semantic routing inference engine 400 may comprise a core controller 402, a topology transformer 404, a prompt constructor 406, an interface 408, an inference engine 410, a natural language transformer 412, and a pattern matcher 414. The example core controller 402 serves as the central orchestration hub of the example semantic routing inference engine 400. For example, the core controller 402 may handle incoming requests, make routing decisions regarding those requests, and manage the request lifecycle through the semantic routing inference engine 400. In some examples, the core controller 402 may be scalable by deploying in distributed environments with load balancing and horizontal scaling. The core controller 402 may further track the health, performance metrics, and request statistics associated with the semantic routing inference engine 400.

In some examples, the core controller 402 may be implemented as a stateless service for scalability, allowing multiple instances to handle requests in parallel. In some examples, the core controller 402 may be deployed as a standalone microservice. In some examples, the core controller 402 may be integrated into a larger application. The core controller 402 may be built using frameworks such as, for example, Spring Boot (Java), FastAPI (Python), or Node.js with Express, depending on performance requirements and existing infrastructure.

In some examples, the core controller 402 may utilize a Command design pattern to manage requests and encapsulate routing requests and operations. In some such examples, each routing decision may be represented as a discrete command object. This approach may enable features like request queuing, priority handling, and the ability to implement different execution strategies. For high-availability deployments, the core controller 402 may implement multiple controller instances to operate behind a load balancer. In some such examples, state management may be handled through a distributed cache like Redis or Memcached.

In some examples, the core controller 402 may implement a circuit breaker pattern (using libraries like Hystrix or Resilience4j) to manage component failures or otherwise handle errors. In some examples, the core controller 402 may implement a retry strategy that uses exponential backoff with jitter to prevent thundering herd problems during recovery. In some examples, the core controller 402 may use an event-driven architecture with message queues (RabbitMQ, Apache Kafka) for improved scalability and fault tolerance. In some examples, the core controller 402 may implement a request-reply pattern with a message broker like NATS or NATS Streaming. In some examples, the core controller 402 may implement any combination of the aforementioned strategies or architectures, or similar known strategies or architectures.

The example topology transformer 404 analyzes and transforms network structures. In some examples, the topology transformer 404 may employ graph theory algorithms to understand network topology and structure and changes thereto (e.g., the addition/adjustment/deletion of nodes and/or connections between nodes). In some examples, the topology transformer 404 uses semantic extraction to extract meaningful information about nodes and edges, such as capabilities, dependencies, and performance metrics. In some examples, the topology transformer 404 may perform abstraction to simplify network representations so that only relevant details are included for routing decisions. The example topology transformer 404 may identify and eliminate semantically redundant paths and nodes to improve and optimize routing efficiency. Furthermore, the example topology transformer 404 may track network changes and update the topology representation accordingly.

In some examples, the topology transformer 404 may be implemented using graph processing libraries like NetworkX (Python), JGraphT (Java), or neo4j for larger scale deployments. The topology transformer 404 may maintain an internal graph representation using adjacency lists, matrices, or the like, depending on the network density. In some examples, the topology transformer 404 may identify subnetworks based on community detection algorithms such as, for example, Louvain or Girvan-Newman. In some examples, the topology transformer 404 may analyze paths based on variants of Dijkstra's algorithm or A* search optimized for semantic weights. In some examples, such as for static networks, the topology transformer 404 may operate in batch mode. In some examples, such as for dynamic topologies, the topology transformer 404 may operate in stream mode. In some such examples, the topology transformer 404 may track changes using a version control approach similar to Git's directed acyclic graph (DAG).

In some examples, the topology transformer 404 may use specialized graph databases for persistence. In some examples, such as for large networks, the topology transformer 404 may implement distributed graph processing using systems like Apache Giraph or Pregel. In some examples, such as for real-time applications, the topology transformer 404 may maintain an in-memory graph representation with periodic persistence to a backing store.

The example topology transformer 404 may use, based on the structure and relationships between network nodes, traditional graph algorithms to collect data embedded in the individual nodes without semantically understanding the network nodes. In some examples, the topology transformer 404 only collects data pertinent for constructing a prompt for the inference engine 410. In some such examples, this enables the inference engine 410 to output a focused and concise representation of the network, rather than a raw adjacency matrix, a list of nodes and edges, or some other similar full serialization.

The example prompt constructor 406, based at least on data from the example topology transformer 404, constructs prompts for the example inference engine 410. In some examples, the prompt constructor 406 implements a template-based architecture using a combination of design patterns including Builder, Strategy, and Chain of Responsibility to structure prompts consistently. The example prompt constructor 406 may store templates in a variety of formats (YAML, JSON, or domain-specific languages) and may support inheritance and composition for complex prompt structures. In some examples, the prompt constructor 406 may use known prompt compression techniques to reduce token usage. In some examples, the prompt constructor 406 may employ natural language processing techniques for context integration. In some examples, the prompt constructor 406 may use libraries like spaCy or Stanford NLP for entity recognition and relationship extraction. The example prompt constructor 406 may incorporate historical decisions using various approaches, such as simple caching with LRU policies or sophisticated machine learning models that learn from past routing decisions. In some examples, the prompt constructor 406 may use a rules engine (like Drools) for complex prompt construction logic. In some examples, the prompt constructor 406 may implement a domain-specific language for defining prompt templates. In some examples, such as for high-performance scenarios, the prompt constructor 406 may pre-compile common prompt patterns and use prototype-based cloning for rapid instantiation.

The example prompt constructor 406 may incorporate relevant contextual information, such as network conditions and historical data. In some examples, the prompt constructor 406 may customize prompts based on specific requirements or policies. In some examples, the prompt constructor 406 may validate constructed prompts to ensure generated prompts meet quality and formatting requirements. In some examples, the prompt constructor 406 may tune prompts based on historical performance data and feedback for optimization.

The example interface 408 handles communication with inference engines, LLMs, or the like to ensure that prompts are correctly formatted. In some examples, the interface 408 implements an adapter pattern to support multiple AI providers (OpenAI, Anthropic, local models) with a consistent interface. The example interface 408 may be implemented as a reactive service using frameworks like Project Reactor or RxJava to handle asynchronous communication with AI providers efficiently. In some examples, the interface 408 may validate an output to ensure it meets expected formats and standards. For example, the interface 408 may employ a combination of schema validation (JSON Schema, Protocol Buffers) and semantic validation using predefined rules or learned patterns for response validation. In some examples, the interface 408 may implement a multi-level caching approach by combining in-memory caches (Caffeine, Guava) with distributed caches (Redis) and persistent stores (PostgreSQL with JSONB) for different types of inference results. In some examples, the interface 408 may implement a federated inference approach, distributing requests across multiple AI providers based on cost, performance, or specialization. In some examples, such as for latency-sensitive applications, the interface 408 may implement predictive prefetching of common inference patterns or maintain warm connections to AI providers. The example interface 408 may track response times, success rates, and other key metrics, and manage errors and exceptions from model interactions.

The example inference engine 410 may be a core decision-making component that transforms structured prompts into actionable routing decisions with supported reasoning. In some examples, the inference engine 410 is an LLM. In some examples, the inference engine 410 may be external to the semantic routing inference engine 400. In some examples, the inference engine 410 may implement a multimodal approach using an ensemble of different LMMs to reduce

```
dependency on any single model. Example 1 illustrates example code for model selection.
def select_model(self, request: RoutingRequest) −> InferenceModel:
  if request.is_time_critical( ):
    return self.lightweight_model # Optimized for speed
  elif request.requires_complex_reasoning( ):
    return self.full_context_model # Maximum context window
  else:
    return self.balanced_model # Default choice
```

### Example 1

In some examples, the inference engine 410 may develop domain-specific fine-tuning pipelines to optimize model performance for specific use cases. For example, the inference engine 410 may create domain-specific training datasets from historical routing decisions. The inference engine 410 may implement feedback loops to capture domain expert knowledge. In some examples, the inference engine 410 may develop specialized validation metrics for different industries. The example inference engine 410 may build domain-specific prompt templates that encode industry best practices.

Additionally, the inference engine 410 may perform regular evaluation and benchmarking of model performance to ensure consistent quality. In some such examples, the inference engine 410 may implement automatic model switching based on the evaluation and benchmarking of model performance. In some examples, the inference engine 410 may establish performance benchmarks for different operational contexts. Additionally or alternatively, the inference engine 410 may use any other system that can perform semantic inferences and understanding of queries, requests, and calls. Likewise, the processing stages could be implemented differently, depending on the specific requirements and capabilities of the underlying inference system.

In some examples, the inference engine 410 may perform multiple stages of processing. The inference engine 410 may implement model-specific pre-processing as a first stage. In some examples, the inference engine 410 may format and optimize prompts for integration with particular LLMs. For example, the inference engine 410 may apply token-level optimizations (removing redundant tokens, compressing repetitive patterns), incorporate relevant cached responses to provide context, adjust prompt structure based on model-specific requirements, prune irrelevant context to stay within token limits, and normalize input formats for consistency. In some examples, the model-specific pre-processing may be an optional processing stage.

The inference engine 410 may implement core processing as a second stage. In some examples, the inference engine 410 may utilize an LLM to perform semantic reasoning. In some examples, the semantic reasoning comprises determining inferences based on predefined relationships equating concepts to particular data, logical implications of such relationships, knowledge graphs, predefined rules, and a knowledge base. In some examples, the inference engine analyzes the (preprocessed) prompt using a particular LLM. The example inference engine 410 may consider multiple routing options or paths throughout a network (at the node level, and collectively through the entire network) and their implications. In some examples, the inference engine 410 may evaluate trade-offs between different paths (e.g., based on the probability distributions of subsequent nodes, the objectives and/or capability of nodes, network status, network topology, node type, query context, speed, bandwidth, etc.). The inference engine 410 may also implement traditional routing algorithms for critical paths. Based on considering the multiple routing paths, the example inference engine 410 may output a structured path decision. In some examples, the inference engine 410 may provide supporting reasoning for the structured path decision.

In some examples, the multiple routing options or paths considered by the inference engine 410 may be current routing options or paths through a network that results in an output in response to a query. In some examples, the multiple routing options or paths considered by the inference engine 410 may be hypothetical options or paths through the network based on variations of the query, variations of the network topology, etc.).

In some examples, the inference engine 410 may implement validation as a third processing stage. The example inference engine 410 may verify any decision meets all constraints. In some examples, the inference engine 410 may check for logical consistency (e.g., determine whether the determined path is a valid option). In some examples, the inference engine 410 may ensure that complete reasoning is provided. The validation by the example inference engine 410 may serve as a sanity check to ensure the decision is valid and consistent. In some examples, the validation may be an optional processing stage.

In some examples, the aforementioned processes implemented by the inference engine 410 may be computationally intensive, especially considering the replications of such processes across all nodes of a large scale network. To mitigate overloading, the inference engine 410 may implement multi-level caching strategies (in-memory, distributed, and persistent), use predictive pre-computation for common routing patterns, implement request batching and priority queuing for high-traffic scenarios, deploy edge computing solutions to reduce latency in geographically distributed networks, utilize model quantization and compression techniques, implement adaptive resource allocation based on traffic patterns, and/or combine lightweight models for simple decisions and full LLMs for complex cases.

Furthermore, the inference engine 410 may perform the following optimization techniques including, for example, prompt compression techniques to reduce token usage; model pruning, distillation, and compression for creating lightweight, domain-specific variants; quantization for reduced memory footprint; dynamic batch processing for high-volume routing scenarios; parallel processing pipelines for complex network analyses; adaptive model selection; GPU acceleration for graph processing operations; hardware-specific optimizations and memory-efficient graph representations for large-scale networks.

The example natural language transformer 412 may determine a natural language representation of incoming data (e.g., a query). The example natural language transformer 412 may also determine a natural language representation of the objectives and/or capabilities of a node. In some examples, the natural language transformer 412 may output natural language representations to the prompt constructor 406, the interface 408, and/or the pattern matcher 414 to determine or update probability distributions and/or generate natural language prompts.

The example pattern matcher 414 may, based on data received from the natural language transformer 412, compare the natural language representation of incoming data with the natural language representation of subsequent nodes to determine an initial probability distribution indicating probabilities of success in routing incoming data from one node to one or more other nodes. For example, if incoming data is indicative of a mathematical request, the pattern matcher 414 may determine that mathematical type nodes (determined by the natural language representations of the objectives and capabilities of the node) have a higher likelihood of success in providing an accurate and quick response than other node types (e.g., linguistic type nodes). As described herein, the pattern matcher 414 may initially determine the probability distributions of the nodes subsequent to the node which comprises the semantic routing inference engine 400. In some examples, the pattern matcher 414 may additionally update the probability distributions of the nodes subsequent to the node which comprises the semantic routing inference engine 400 based on routing data (hypothetical and actual), contextual information, network topology, etc.

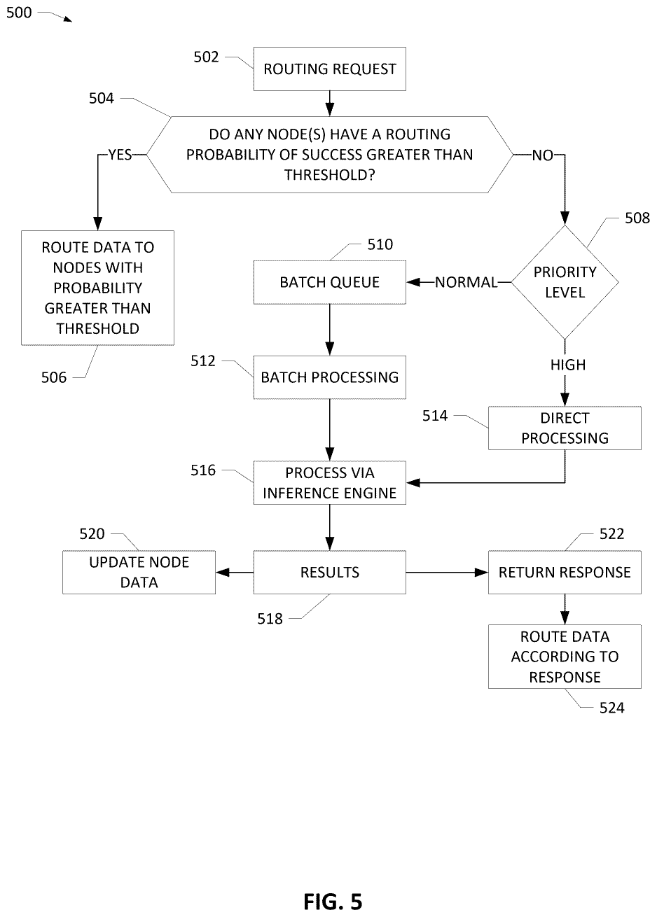

FIG. 5 illustrates an example process 500 for optimizing routing through a network. The process 500 may begin at step 502 upon receipt of a routing request, which may be in the form of a query. The routing request may be received by the semantic routing inference engine 400. At step 504, the natural language transformer 412 may determine a natural language representation of the request/query. The natural language transformer 412 may also determine natural language representations of the subsequent nodes of a network. The pattern matcher 414 may compare the natural language representation of the query to the natural language representations of the subsequent nodes of the network to determine a probability distribution identifying probabilities of success for routing the query through the network via the subsequent nodes. For example, the pattern matcher 414, based on comparing the natural language representation of the query to the natural language representations of the subsequent nodes of the network, determine that for three subsequent nodes, the probabilities are 0.51, 0.33, and 0.16. In some examples, the probabilities of success may be based on determining whether the subsequent nodes have the capabilities to handle what is within the routing request/query (e.g., if a mathematical query comes in, then a mathematical based node may have a higher probability of success than a linguistical based node).

In some examples, the pattern matcher 414 may further determine whether any of the probabilities of success for routing the query through the network via the subsequent nodes satisfy a threshold. In some such examples, the pattern matcher 414 may compare the probabilities of success for routing the query through the network via the subsequent nodes to a configurable threshold, and if any of the probabilities of success for routing the query through the network via the subsequent nodes exceeds the configurable threshold then the core controller 402 may route the query to the subsequent nodes associated with those probabilities exceeding the threshold. In the aforementioned example, the pattern matcher 414 may set the threshold to be 0.50 and only the subsequent node associated with a probability of success of 0.51 may exceed this threshold and have data routed thereto. In other examples, multiple subsequent nodes may exceed the threshold. For example, using the same example above, if the threshold is configured to be 0.3, then the subsequent node associated with a probability of success of 0.51 and the subsequent node associated with a probability of success of 0.33 may exceed the threshold and have data routed thereto). As another example, if the threshold is set to 0, then all of the subsequent nodes may exceed the threshold and have data routed thereto.

In some examples, no subsequent nodes may satisfy the threshold. For example, the threshold may be set extremely high (e.g., 0.99) and no subsequent nodes may have a probability of success this high. Additionally or alternatively, the probabilities of success for routing the query through the network via the subsequent nodes may be too low (e.g., due to incompatibility of the nodes with the query). Alternatively, all subsequent nodes may have an equal probability of success, with none of the nodes exceeding the threshold (e.g., if the threshold is 0.51 and all subsequent nodes are associated with a probability of success of 0.50). In some such examples, the core controller 402 may determine to prompt the inference engine 410 for a routing determination.

Accordingly, if any of the subsequent nodes have a routing probability of success greater than the threshold (step 504: YES), then core controller 402 may route the incoming data (e.g., routing request/query) to those subsequent nodes at step 506. As described herein, the core controller 402 may determine which node to route the incoming data to next based on the probability distribution weighting the various subsequent next nodes. In some examples, the subsequent next node with the highest weighting within the probability distribution is the determined next node. In some examples, a plurality of subsequent next nodes with the highest weightings (e.g., first highest, second highest, third highest, etc.) may be the determined next nodes.

However, if none of the subsequent nodes have a routing probability of success greater than the threshold (step 504: NO), then the core controller 402 may determine to prompt the inference engine 410 for a routing determination. In some examples, the core controller 402 may determine to prompt the inference engine 410 for a routing determination even when subsequent nodes have a routing probability of success greater than the threshold. For example, if there are a plurality of subsequent nodes that have a routing probability of success greater than the threshold, the core controller 402 may prompt the inference engine 410 to determine a subset of that plurality of subsequent nodes.

At step 508, the core controller 402 may determine a priority level associated with the incoming data. In some examples, the core controller 402 may determine whether the priority level is high or normal/low. In some examples (such as for non-high priority queries), the inference engine 410 may process incoming data in batch processing. In some such examples, if the core controller 402 determines the priority level associated with the incoming data is normal (or low) priority (step 508: NORMAL), then the core controller 402 may queue processing of the incoming data in a batch queue (step 510). At some time later, the core controller 402 may prepare the incoming data in the batch queue for batch processing (step 512). For example, the core controller 402 may direct the prompt constructor 406 to generate one (or more) prompt(s) to request routing decisions on all data within the batch queue at a same time (or within a threshold amount of time).

If the core controller 402 determines the priority level associated with the incoming data is high priority (step 508: HIGH), then the core controller 402 may prepare the incoming data for direct processing (step 514). For example, the core controller 402 may direct the prompt constructor 406 to generate a prompt to request a routing decision on just the most recent incoming data immediately (or within a threshold amount of time). At step 516, the inference engine 410 may process the prompts according to either step 514 or 512.

In examples where the inference engine 410 is to perform batch processing, the inference engine 410 may perform batch processing serially in the order of the queue. In some examples, the inference engine 410 may process the data in the batch queue according to priority-based request scheduling. In some examples, the inference engine 410 may perform batch processing of all of the data within the batch queue parallelly. In some examples, the inference engine 410 may perform dynamic batch sizing based on load.

In examples where the inference engine 410 is to perform direct processing, the inference engine 410 may process the incoming data as soon as possible. In some examples, the inference engine 410 may directly process the data prior to the data stored in the batch queue. In some examples, the inference engine 410 may interrupt (e.g., pause) the batch processing at step 512 to perform the direct processing at step 514. At step 518, the inference engine 410 may determine the results of processing the prompt(s). At step 520, the pattern matcher 414 can update the probability distributions to add, increase, or decrease weights based on the results of the processing. At step 522, the inference engine 410 may return the results of the processing in a response to the routing request/query in a response to the core controller 402 or to a client. At step 524, the core controller 402 may route the data according to the response. The example process 500 may repeat multiple times for the same data and/or may repeat each time a node receives new incoming data.

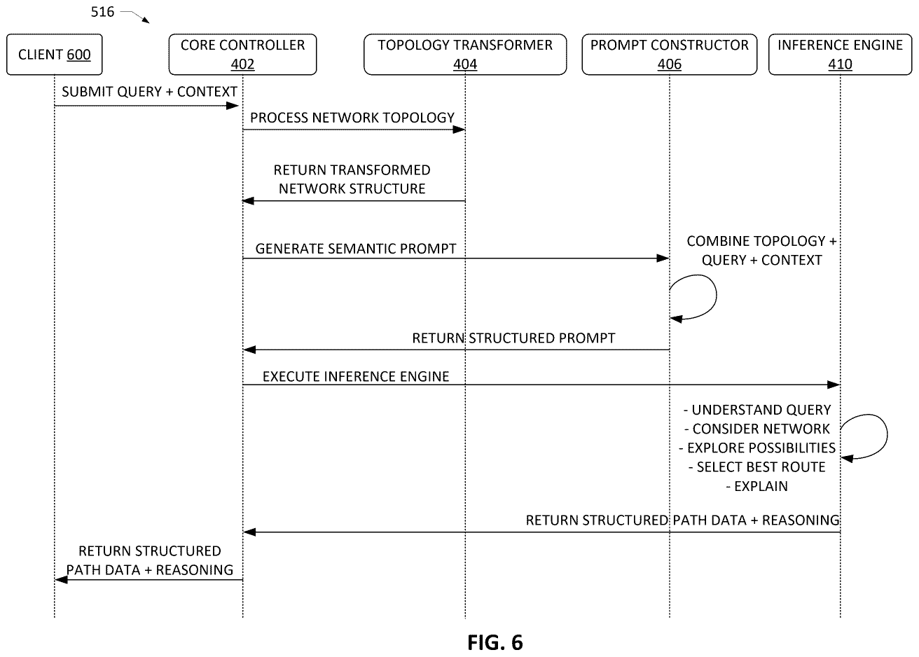

FIG. 6 illustrates a timing diagram detailing various steps the various components of the example semantic routing inference engine 400 may implement during operation. In some examples, the timing diagram of FIG. 6 may illustrate one or more actions by the various components of the semantic routing inference engine 400 in implementing step 516 of FIG. 5. As illustrated in FIG. 6, a client 600 may submit a query. The core controller 402 of the example semantic routing inference engine 400 may receive the client query. For example, the client 600 may submit a query such as, for example, “Find me a route that . . . ” is the quickest, is the most accurate, provides a specific response, etc. The client 600 may further submit relevant context such as, for example, the request including streaming media and may require high bandwidth.

Although a routing decision may be made by comparing the natural language representation of the query to the natural language representation of the subsequent nodes as discussed above, in the illustrated example of FIG. 6, it is presumed that no such routing decision has been made (e.g., because no nodes had a probability of success satisfying the threshold, multiple nodes have equal probabilities of success, etc.). In some such examples, the core controller 402 having received the query and/or context may ping the topology transformer 404 to provide the network topology and/or a transformed network structure (e.g., optimized and/or simplified network topology). The topology transformer 404 may process the network topology, transform and/or format the network representation, and return the transformed network structure to the example core controller 402. As described herein, the transformed network structure may comprise an optimized and/or simplified representation of the network. The core controller 402 may forward the query, the network topology (and/or transformed network structure), and any context to the prompt constructor 406. The prompt constructor 406 may combine the query, the network topology (and/or transformed network structure), and any context to form a structured prompt. In some examples, the prompt constructor 406 uses templates, natural language processing, libraries, patterns, prompt cloning, and/or any combination thereof to construct the prompt. Once the prompt constructor 406 has constructed the prompt, the prompt constructor 406 returns the structured prompt to the core controller 402. The core controller 402 may forward to the structured prompt to the inference engine 410 for execution via the interface 408. In some examples, the prompt constructor 406 may forward the structured prompt to the inference engine 410 via the interface 408 without returning the structured prompt to the core controller 402.

Based on the structured prompt, the inference engine 410 may be able to understand the query. In some examples, the inference engine 410 performs semantic reasoning on the query itself to determine context. In some examples, the inference engine 410 receives context from the core controller 402 (or the prompt constructor 406). In some examples, the inference engine 410 receives context semantically from the query itself, as well as from the core controller 402 or the prompt constructor 406.

In some examples, the inference engine 410 explores possible routes based on the query, the network topology (and/or transformed network structure), and any context. For example, the inference engine 410 may determine that there are ten possible subsequent nodes to which the query may be routed. Each possible subsequent node may be associated with a weight or probability score between zero and one. As described herein, the weight or probability may be determined based on actual previous routing through the network. In some examples, the type, capabilities, number of subsequent connections, resource availability, speed, and frequency of use of the subsequent node may be taken into account to determine the weight or probability for future routing.

In some examples, the weight or probability may be determined based on hypothetical routing of a query through the network. For example, the inference engine 410 may process each of the routes to the ten possible subsequent nodes (without actually forwarding the query to any of the subsequent nodes) and analyze the outcome, speed, and/or accuracy of each routing decision. In some examples, the inference engine 410 may create one or more variations of the query and process each of the routes to the ten possible subsequent nodes (without actually forwarding the one or more variations of the query to any of the subsequent nodes) and analyze the outcome, speed, and/or accuracy of each routing decision. In some examples, the inference engine 410 may consider one or more variations to the network topology (such as the addition or deletion or nodes and/or connections) and process each of the routes to the various possible subsequent nodes (without actually forwarding the query to any of the subsequent nodes) and analyze the outcome, speed, and/or accuracy of each routing decision. In some examples, the inference engine 410 may do any and all of the above hypothetical routing analysis to determine an appropriate weight or probability to associate with a given subsequent node.

In some examples, the context of the query is important for determining the appropriate weight or probability for a given node. For example, the query may indicate that speed is preferred over accuracy. In some such examples, the inference engine 410 may determine a higher weight for hypothetical (or actual) routes that arrive at an outcome within a threshold amount of time (e.g., within seconds), and the inference engine 410 may determine a lower weight for hypothetical (or actual) routes that arrive at an outcome after the threshold amount of time. Other queries, however, may indicate that accuracy is preferred over speed. In some such examples, the inference engine 410 may determine a higher weight for hypothetical (or actual) routes that arrive at an outcome above a threshold level of accuracy (e.g., 95% or higher accuracy), and the inference engine 410 may determine a lower weight for hypothetical (or actual) routes that arrive at an outcome below the threshold level of accuracy.

Because the above-described hypothetical routing analysis may require considerable resources, despite no actual routing or output occurring, the inference engine 410 may perform the hypothetical routing analysis during periods of low network activity when resources are plentiful. In some examples, the inference engine 410 may perform the hypothetical routing analysis when a first threshold amount of resources are available. In some examples. the inference engine 410 may perform hypothetical routing analysis in an ad-hoc manner when lower amounts of resources are available. For example, the inference engine 410 may perform some hypothetical routing analysis when a second threshold amount of resources are available, where the second threshold amount of resources is lower than the first threshold amount of resources. In some examples, every possible hypothetical route may be analyzed by the inference engine 410. In some examples, the inference engine 410 may analyze a threshold amount of possible hypothetical routes (e.g., 85%).

The semantic routing inference engine 400 may implement resource-based prioritization mechanisms to determine when and how extensively to perform hypothetical routing analysis. In some examples, the semantic routing inference engine 400 may monitor available computational resources including processing capacity, memory availability, network bandwidth, and concurrent load. When available resources exceed a first threshold, the semantic routing inference engine 400 may perform extensive hypothetical routing scenarios covering a higher percentage of possible routing paths. When available resources fall between the first threshold and a second lower threshold, the semantic routing inference engine 400 may perform selective hypothetical routing analysis covering a reduced percentage of possible routing paths. When available resources fall below the second threshold, the semantic routing inference engine 400 may prioritize processing actual routing requests over hypothetical analysis. In some examples, the semantic routing inference engine 400 may implement priority hierarchies where certain network functions take precedence over others based on criticality, timing requirements, or system objectives. This resource-based prioritization may enable the semantic routing inference engine 400 to continuously optimize its analysis depth based on real-time system conditions, balancing accuracy improvements from additional hypothetical analysis against resource constraints and immediate routing needs.

Each node in a network may perform the above hypothetical routing analysis. In some examples, the hypothetical routing analysis may be performed at each node simultaneously. In some examples, the above hypothetical routing analysis may be performed at some nodes simultaneously and at other nodes sequentially. For example, respective semantic routing inference engines at a first set of nodes may perform the hypothetical routing analysis as to a second set of nodes (e.g., the subsequent nodes adjacent the first set of nodes) at a first time, and respective semantic routing inference engines at the second set of nodes may perform the hypothetical routing analysis as to a third set of nodes (e.g., the subsequent nodes adjacent the second set of nodes) at a second time . . . and respective semantic routing inference engines at the (n−1)th set of nodes may perform the hypothetical routing analysis as to an nth set of nodes (e.g., the subsequent nodes adjacent the (n−1)th set of nodes) at an (n−1)th time.

Whether the weight or probability is determined based on hypothetical routing analysis, the actual routing of data, or both, the pattern matcher 414 for a node may store/update the weights/probabilities in rapid access storage, such as cache memory, as a probability distribution (e.g., a table, chart, graph, etc. associating a weight or probability to each subsequent node), or as part of the natural language representation of the node itself. In some such examples, this may involve multi-level caching (L1: In-memory, L2: Distributed), partial cache invalidation based on topology changes, cache warming strategies, and/or time-based cache expiration policies. In some examples, the multi-level caching architecture may differ according to different types of routing decisions. For example, one level may be configured for predictive pre-computation of common routes, another level may be configured for cache invalidation strategies based on network topology changes, another level may be configured for distributed caching for geographically dispersed networks, and another level may be configured for partial cache updates for incremental network changes. In some examples, the weights, probability distributions, or the natural language representations are updated constantly, such as, for example, based on subsequent additional hypothetical routing analyses and/or actual routing decisions.

Based on the data, the network topology, the context, and/or any probability distributions, the inference engine 410 may determine the next best node(s) to forward the query. In some examples, the inference engine 410 may determine structured path data based on the determination of the next best node. In some examples, the inference engine 410 may utilize natural language processing and LLMs to prepare supportive reasoning for the determined structured path data. The inference engine 410 may forward the structured path data and the supportive reasoning to the core controller 402. The core controller 402 may respond to the client 600 with the structured path data and supportive reasoning.

In some examples, the core controller 402 may forward the data, the structured path data, and the supportive reasoning to the determined next best node(s), rather than the client 600. The next best node(s) may perform the above-described process (replacing client 600 in FIG. 6 with the previous node). In some examples, as data is routed through a network and each node determines the next best node as explained above, the core controller 402 may compile together any and all previous node routing decisions based on received structured path data and supportive reasoning into compiled path data. Accordingly, subsequent nodes can perform the above-described process, forward the data and the compiled path data to another subsequent node. Once the last node in the network receives the data and the compiled path data, the last node may perform the above-described process and then respond to the client 600 with the compiled path data (including each prior structured path data and supportive reasoning). In some such examples, the core controller 402 of the last node in the network may create an entire path, from start to finish, through the network. In some such examples, the data may therefore proceed through and be processed by the entire network before the core controller 402 responds to the client 600.

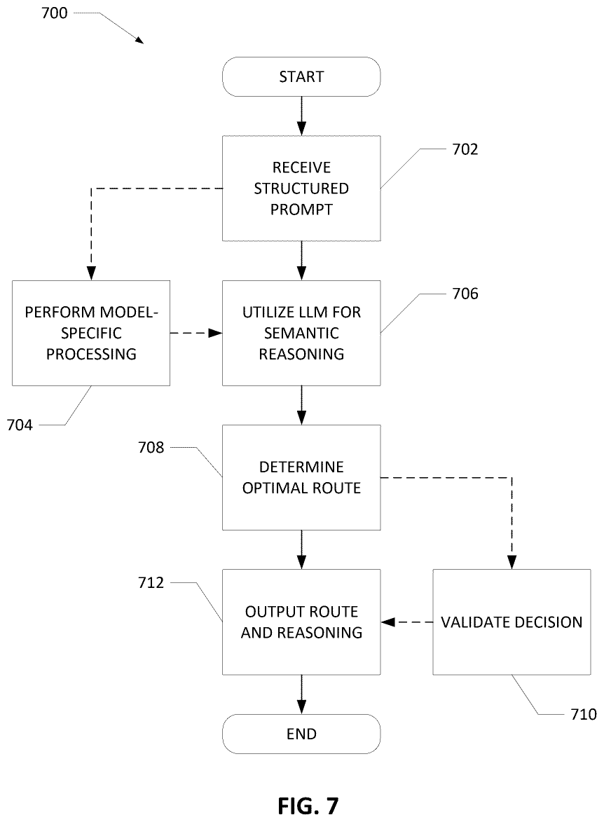

In some examples, the inference engine 410 may perform additional processing beyond that described with respect to FIG. 6. FIG. 7 illustrates a process 700 including such additional processing. For example, the inference engine 410 may receive a structured prompt at step 702 (similarly as described with FIG. 6). At step 704, the inference engine 410 may optionally perform model-specific processing depending on the particular LLM being utilized. As described above with respect to FIG. 4, this may include applying token-level optimizations, adjusting prompt structure based on model-specific requirements and token limits, and/or normalizing input formats for consistency. At step 706, the inference engine 410 may utilize the LLM for semantic reasoning of the prompt and underlying query. Furthermore, at step 708 the inference engine 410 may determine the optimal route. As described with reference to FIG. 6, this may involve, for a single node, determining the next best node based on probability distributions, the query, the type and capabilities of the node, context, network topology, etc. Additionally or alternatively, the inference engine 410 may determine the optimal route based on a compilation of individual node decisions of the next best node to form the best route through the network.

In some examples, the inference engine 410 may (optionally) validate its decision of the next best node or best route through the network at step 710. As described above with respect to FIG. 4, this may involve checking that the next node or best route are valid options, reasoning is provided for each node decision, all reasoning is logical, and the decision is historically consistent. In some examples, the inference engine 410 may implement detailed logging and audit trails for all routing decisions. The example inference engine 410 may develop visualization tools for decision paths and reasoning processes. In some examples, the inference engine 410 may establish confidence scoring systems for routing decisions. The example inference engine 410 may create automated validation pipelines to verify routing decisions against predefined rules. In some examples, the inference engine 410 may implement A/B testing frameworks to compare decisions against baseline routing strategies. The example inference engine 410 may further develop explainable AI interfaces that break down complex decisions into understandable components. At step 712, the inference engine 410 may output its route decision and reasoning.

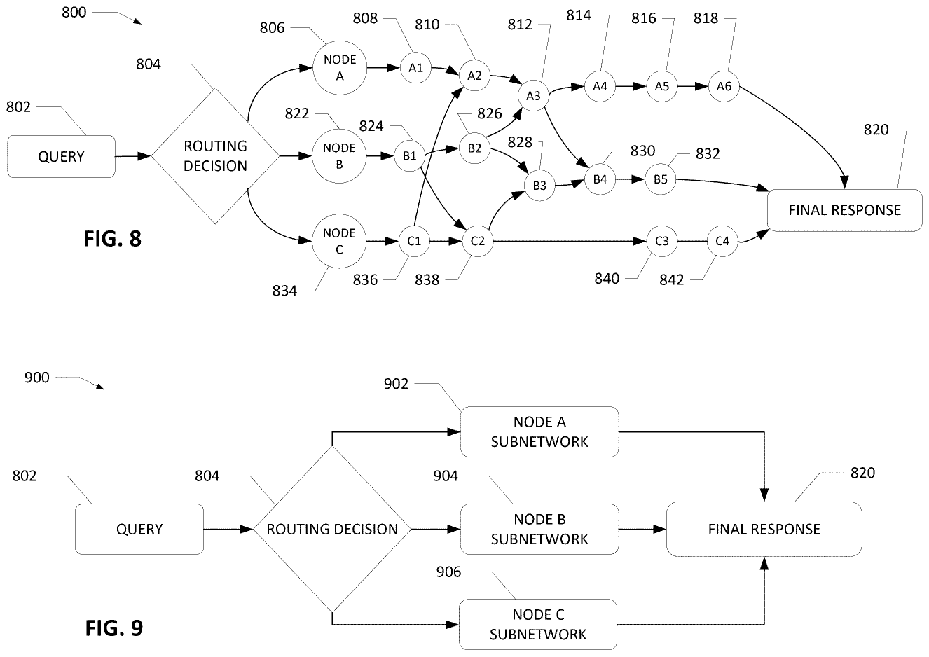

FIG. 8 illustrates a representation of an example network 800 in which the example semantic routing inference engine 400 may operate. As illustrated in FIG. 8, the example semantic routing inference engine 400 may receive a query 802. In some examples, the core controller 402 of the example semantic routing inference engine 400 receives the query 802. The query 802 may be a request, a call, or may otherwise be input data to be acted upon by the example semantic routing inference engine 400. To address the query 802, the example semantic routing inference engine 400 may need to make a routing decision 804. For example, the semantic routing inference engine 400 may need to determine the most optimal path through the network 800.

The example network 800 may comprise a number of nodes, a number of connections between the nodes, and a number of paths. As illustrated in FIG. 8, the network may comprise a first path including a first node 806 (Node A), a second node 808 (Node A1), a third node 810 (Node A2), a fourth node 812 (Node A3), a fifth node 814 (Node A4), a sixth node 816 (Node A5), and a seventh node 818 (Node A6). The first path may terminate at a final response 820. In some examples, the final response 820 may be an answer to the query 802. Likewise, the network 800 may comprise a second path including an eighth node 822 (Node B), a ninth node 824 (Node B1), a tenth node 826 (Node B2), an eleventh node 828 (Node B3), a twelfth node 830 (Node B4), and a thirteenth node 832 (Node B5). Like the first path, the second path may terminate at the final response 820. Additionally, the network 800 may comprise a third path including a fourteenth node 834 (Node C), a fifteenth node 836 (Node C1), a sixteenth node 838 (Node C2), a seventeenth node 840 (Node C3), and an eighteenth node 842 (Node C4). Like the first and second paths, the third path may terminate at the final response 820.

As shown in FIG. 8, there may be additional paths, beyond the three paths mentioned above, formed through connections of nodes between the three aforementioned paths. For example, additional paths may include some nodes from the first path and some nodes from the second path (e.g., A->A1->A2->A3->B4->B5 and B1->B2->A3->A4->A5->A6. Other paths may include some nodes from the second path and some nodes from the third path (e.g., B1->C2->C3->C4, B1->C2->B3->B4->B5, and C1->C2->B3->B4->B5). Some paths may include some nodes from the first path and some nodes from the third path (C1->A2->A3->A4->A5->A6). Paths may even include nodes from the first, second, and third paths (e.g., C1->A2->A3->B4->B5). Of course, other paths are apparent from the illustration in FIG. 8. In some examples, as the number of nodes and connections increase, so do the potential paths through a particular network.

Due to the increasing complexity of networks, the example topology transformer 404 may transform the topology of the network 800 into a transformed network 900. As shown in FIG. 9, the topology transformer 404 may simplify the network 800 by replacing the complex node/connection representations with a first (Node A) subnetwork 902, a second (Node B) subnetwork 904, and a third (Node C) subnetwork 906 based on the nodes and connections within network 800). This reduces the complexity of the routing decision 804 to a determination between three subnetworks as opposed to determining between the large number of possible paths referenced above.

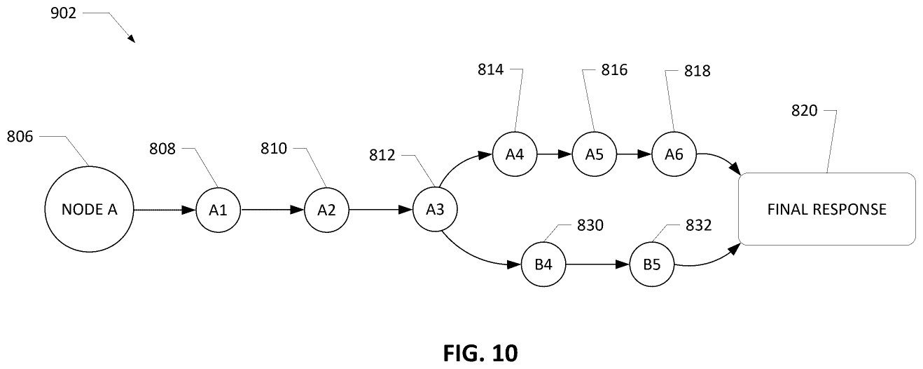

For example, as shown in FIG. 10, the topology transformer 404 may create the first (Node A) subnetwork 902 based on the first node 806 (Node A), the second node 808 (Node A1), the third node 810 (Node A2), the fourth node 812 (Node A3), the fifth node 814 (Node A4), the sixth node 816 (Node A5), the seventh node 818 (Node A6), the twelfth node 830 (Node B4), and the thirteenth node 832 (Node B5). As shown in FIG. 10, the first (Node A) subnetwork 902 may comprise every node, connection, and path starting from the first node 806 (Node A) and ending at the final response 820.

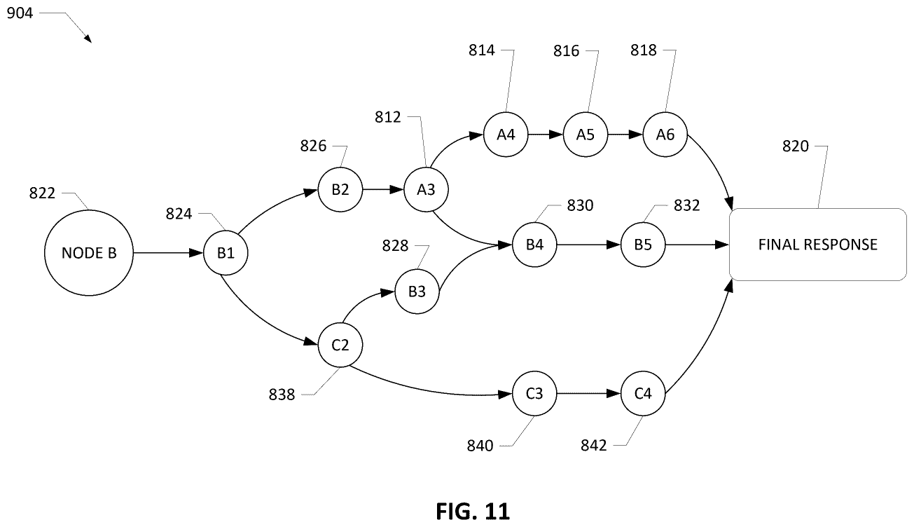

Likewise, as shown in FIG. 11, the topology transformer 404 may create the second (Node B) subnetwork 904 based on the eighth node 822 (Node B), the ninth node 824 (Node B1), the tenth node 826 (Node B2), the fourth node 812 (Node A3), the fifth node 814 (Node A4), the sixth node 816 (Node A5), the seventh node 818 (Node A6), the sixteenth node 838 (Node C2), the eleventh node 828 (Node B3), the twelfth node 830 (Node B4), and the thirteenth node 832 (Node B5), the seventeenth node 840 (Node C3), and the eighteenth node 842 (Node C4). As shown in FIG. 11, the second (Node B) subnetwork 904 may comprise every node, connection, and path starting from the eighth node 822 (Node B) and ending at the final response 820.

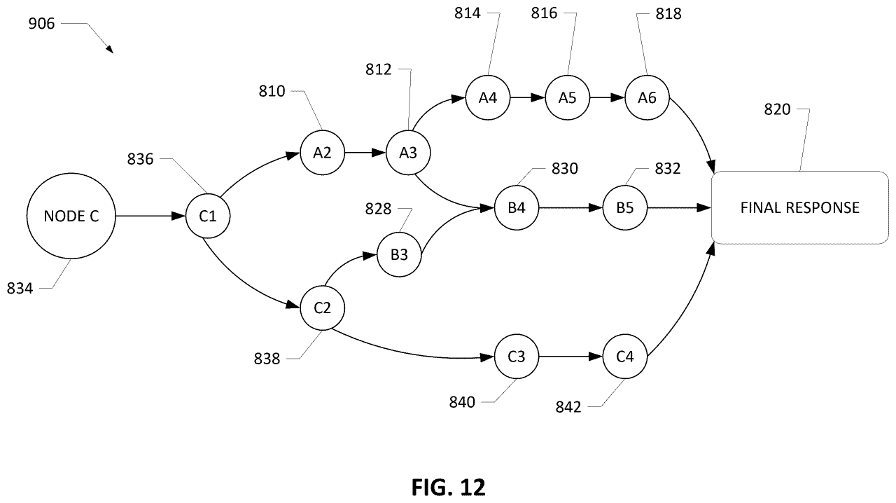

As shown in FIG. 12, the topology transformer 404 may create the third (Node C) subnetwork 906 based on the fourteenth node 834 (Node C), the fifteenth node 836 (Node C1), the third node 810 (Node A2), the fourth node 812 (Node A3), the fifth node 814 (Node A4), the sixth node 816 (Node A5), the seventh node 818 (Node A6), the twelfth node 830 (Node B4), and the thirteenth node 832 (Node B5), the sixteenth node 838 (Node C2), the eleventh node 828 (Node B3), the seventeenth node 840 (Node C3), and the eighteenth node 842 (Node C4). As shown in FIG. 12, the third (Node C) subnetwork 906 may comprise every node, connection, and path starting from the fourteenth node 834 (Node C) and ending at the final response 820.

In some examples, the topology transformer 404 may create different subnetworks. In some examples, the topology transformer 404 may create subnetworks within subnetworks. For example, as shown in FIGS. 10-12, each of the first (Node A) subnetwork 902, the second (Node B) subnetwork 904, and the third (Node C) subnetwork 906 comprise the fourth node 812 (Node A3), the fifth node 814 (Node A4), the sixth node 816 (Node A5), the seventh node 818 (Node A6), the twelfth node 830 (Node B4), and the thirteenth node 832 (Node B5). Likewise, the second (Node B) subnetwork 904 and the third (Node C) subnetwork 906 only differ by two nodes (e.g., the ninth node 824 (Node B1), the tenth node 826 (Node B2) in the second (Node B) subnetwork 904 vs. the fifteenth node 836 (Node C1), the third node 810 (Node A2), in the third (Node C) subnetwork 906).

Accordingly, the topology transformer 404 may create a subnetwork within both the second (Node B) subnetwork 904 and the third (Node C) subnetwork 906, with such a subnetwork including the fourth node 812 (Node A3), the fifth node 814 (Node A4), the sixth node 816 (Node A5), the seventh node 818 (Node A6), the twelfth node 830 (Node B4), and the thirteenth node 832 (Node B5), the sixteenth node 838 (Node C2), the eleventh node 828 (Node B3), the seventeenth node 840 (Node C3), and the eighteenth node 842 (Node C4). And, within that subnetwork (and also within the first (Node A) subnetwork 902), the topology transformer 404 may create a subnetwork including the fourth node 812 (Node A3), the fifth node 814 (Node A4), the sixth node 816 (Node A5), the seventh node 818 (Node A6), the twelfth node 830 (Node B4), and the thirteenth node 832 (Node B5).

With the various subnetworks created by the topology transformer 404, routing decisions may be made for each various subnetwork, thereby decreasing the complexity in routing decisions. This may be important as networks evolve to include new nodes and connections between nodes. As such, the topology transformer 404 may continue to analyze the network and any subnetworks, detect any changes occurring therein, and update the network/subnetwork topologies. While the example networks described herein are illustrated in FIGS. 8-12 in a graphical sense, these networks may be similarly represented in a table, hierarchy, tree, or other format.

As discussed above, the inference engine 410 may be used to make the routing decision 804, and the example prompt constructor 406 may be used to construct a prompt to feed to the inference engine 410 to complete the routing decision 804. Example 2 illustrates an example prompt based on the query 802, contextual information about the network 800, the representations of the first (Node A) subnetwork 902, the second (Node B) subnetwork 904, and the third (Node C) subnetwork 906, and the final response 820, requesting the most optimal path through network 800.

Given [query 802], [context of network 800], and [subnetworks 902, 904, 906], which pathway
optimally reaches [final response 820]?

### Example 2

Using the prompt described above in Example 2, the inference engine 410 may perform the process 700 to make the routing decision 804. For example, the inference engine 410 may analyze the prompt to understand the query 802 (using natural language processing, query context, semantic reasoning, etc.), may consider the network context (e.g., state, bandwidth, complexity, speed, etc.) and topology (e.g., types of nodes, number of nodes, number of connections, length of paths, etc.), may analyze a number of potential paths, may determine the best route, and may provide an explanation for its decision. Example 3 illustrates an example output to the query 802.

```
{
    “decision”: “Node A”,
    “reasoning”: “While Node A provides the longest path to the final response, it is
  the only path that includes both nodes A6 and “B5, which are critical to providing the best
  response.”
  }
```

### Example 3

Example 4 below illustrates another output by the inference engine 410 based on a different query involving content delivery networks (CDNs).

```
{
  “decision”: {
    “selected_path”: “CDN-A”,
    “confidence”: 0.92,
    “alternatives”: [“CDN-B”, “Direct-Route”],
    “reasoning”: {
      “primary_factors”: [
        “High priority requires minimal latency”,
        “Video streaming needs guaranteed bandwidth”,
        “Current load distribution favors CDN-A”
      ],
      “trade_offs”: [
        “Higher cost justified by performance requirements”,
        “Limited regions acceptable for target audience”
      ],
      “validation”: {
        “path_valid”: true,
        “hard_constraints_met”: true,
        “performance_verified”: true
      }
    }
  }
}
```

### Example 4

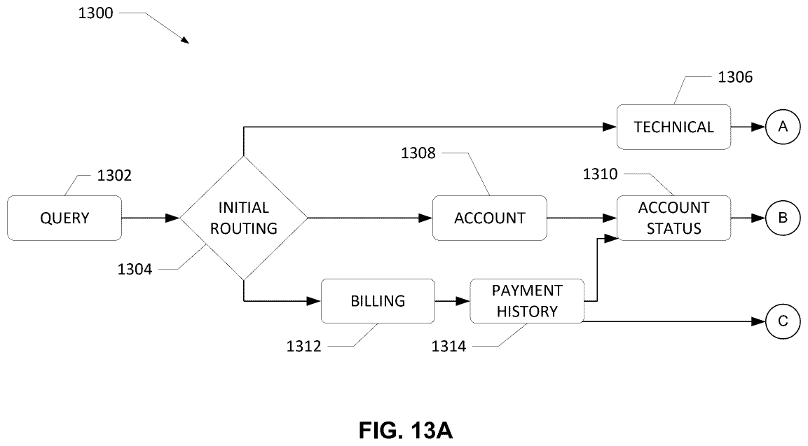

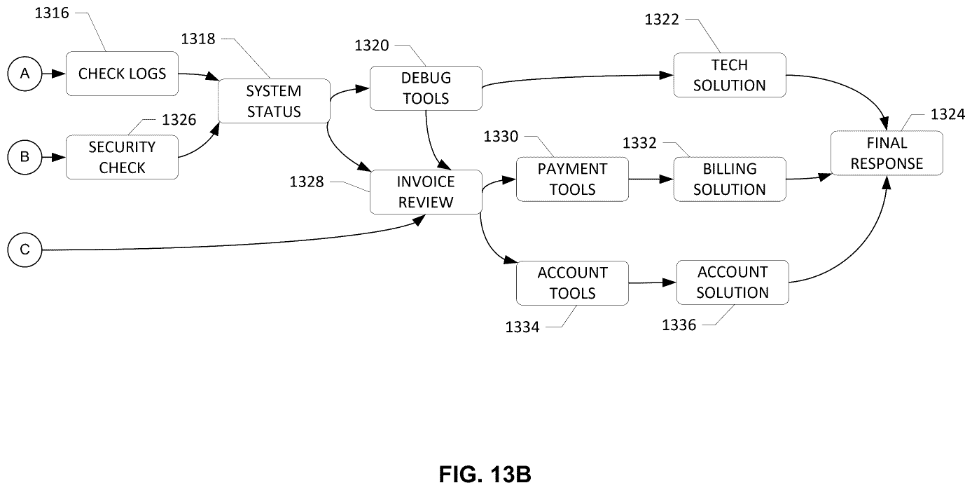

In some examples, various nodes of a network may be associated with different functions. In other words, not all nodes of the network may be able to perform the same types of data manipulation. For example, one node may be configured for mathematical calculations, another node may be configured for chemical analysis, another node may be configured for linguistics, etc. FIGS. 13A-13B illustrate an example network 1300 in which the example semantic routing inference engine 400 may operate and in which the various nodes comprise different functions. For example, the network 1300 may be a customer support network with technical, billing, and account tools. Just like as illustrated in FIG. 8, the example semantic routing inference engine 400 may receive a query 1302. To address the query 1302, the example semantic routing inference engine 400 may need to make a routing decision 1304. For example, the semantic routing inference engine 400 may need to determine the correct path through the network 1300 to arrive at a correct solution (e.g., a technical solution, a billing solution, or an account solution).

As such, the example network 1300 may comprise a number of nodes, including a technical node 1306, an account node 1308, an account status node 1310, a billing node 1312, a payment history node 1314, a check logs node 1316, a system status node 1318, a debug tools node 1320, and a technical solution node 1322 through which a first path to a final response 1324 may be formed. The example network 1300 may further comprise a security check node 1326, an invoice review node 1328, a payment tools node 1330, and a billing solution node 1332 through which a second path to the final response 1324 may be formed. The example network 1300 may also comprise an account tools node 1334 and an account solutions node 1336 through which a third path to the final response 1324 may be formed. Of course, like the network 800 illustrated in FIG. 8, various other paths through the network 1300 exist (as illustrated in FIGS. 13A-13B) besides the aforementioned paths. The topology transformer 404 may create a network topology representation of the network 1300 based on each of the nodes and connections. In some examples, the topology transformer 404 may simplify the network 1300 as described herein to form a transformed network topology.

As indicated by the names of the various nodes, each node may be configured with a specific function (e.g., the check logs node 1316 may be configured to check logs, the debug tools node 1320 may be configured to debug technical issues, the payment tools node 1330 may be configured to facilitate payments to/from a customer, and the account tools node 1334 may be configured to perform account management and maintenance) such that routing the query 1302 through the network 1300 may require functional understanding of the various nodes. To provide that functional understanding, the topology transformer 404 may semantically extract functionality, capabilities, dependencies, and performance metrics of the various nodes. In some examples, the topology transformer 404 provides this functional understanding to the core controller 402 with the (transformed) network topology representation. The core controller 402 may provide the functional understanding of the network 1300, the (transformed) network topology, and the query 1302 to the prompt constructor 406 for combination into a structured prompt for the inference engine 410.

Example 5 illustrates an example prompt generated by the prompt constructor 406 based on the functional understanding of the network 1300, the (transformed) network topology, and the query 1302. In Example 5, the query 1302 may relate to inaccessibility of a user's account, payment, and potential technical issues. Accordingly, the inference engine 410 may determine whether the query 1302 should be routed through the technical node 1306, the account node 1308, or the billing node 1312.

```
{
  “query”: “I can't log into my account and I think it's because my last payment
failed”,
  “context”: {
    “available_paths”: {
      “technical”: {
        “focus”: “System and access issues”,
        “capabilities”: [“log analysis”, “system status”,
“debugging”],
        “cross_connections”: [“billing_tools”, “account_tools”]
      },
      “billing”: {
        “focus”: “Payment and invoice issues”,
        “capabilities”: [“payment history”, “invoice review”,
“payment processing”],
        “cross_connections”: [“account_status”]
      },
      “account”: {
        “focus”: “Account management and security”,
        “capabilities”: [“account status”, “security verification”,
“account tools”],
        “cross_connections”: [“system_status”]
      }
    }
  }
  “objective”: “Determine optimal starting point for resolution”
}
```

### Example 5

Example 6 illustrates an example output by the inference engine 410 based on the prompt of Example 5. Based on the process 516 illustrated and described above with reference to FIG. 6, the example inference engine 410 may provide both a routing decision as well as reasoning for the decision. In Example 6, the inference engine 410 may determine that the account node 1308 is the most optimal starting point to resolve the issue raised by the query 1302.

```
  {
    “decision”: “Account”,
    “reasoning”: “While the query mentions both login issues and payment problems,
starting with Account path is optimal because:
```

| | |
|---|---|
| 1. | Account status check can immediately verify if payment status is |
| | blocking login |
| 2. | Security verification |
| 3. | If needed, can efficiently branch to either Technical (via A2−>T2) or |
| | Billing (via B1) paths |
| 4. | Minimizes potential back-and-forth between departments” |

}

### Example 6

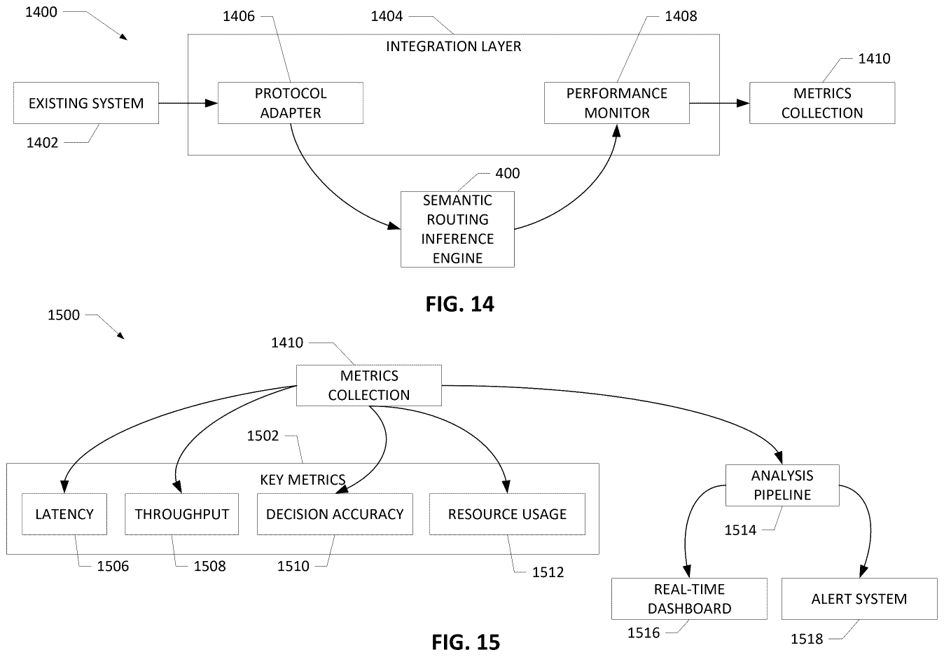

While the above examples illustrate a standalone semantic routing inference engine 400, the semantic routing inference engine may be integrated into existing systems. FIG. 14 illustrates a system 1400 for integrating a semantic routing inference engine to an existing system 1402. To integrate the semantic routing inference engine into the existing system 1402, the system 1400 may include an integration layer 1404. The integration layer 1404 may include REST APIs for synchronous operations and event streams for asynchronous updates. The example integration layer 1404 may comprise a protocol adapter 1406, which may be an interface for adapting legacy systems with the semantic routing inference engine 400. The semantic routing inference engine 400 may connect to a performance monitor 1408 as part of the integration layer 1404.

The example performance monitor 1408 may create comprehensive analytics capabilities for system monitoring and optimization through real-time routing performance dashboards, historical trend analysis, cost optimization reports, network utilization metrics, decision quality assessments, and impact analysis of routing changes. In some examples, the performance monitor 1408 may perform automatic resource scaling, load balancing across inference endpoints, and resource usage monitoring and alerting.

Thereafter metrics may be collected by a metrics collection module 1410. As illustrated by FIG. 14, the integration layer 1404 may fit between the existing system 1402 and the metrics collection module 1410, which may already exist as part of the existing system 1402. In some examples, the metrics collection module 1410 may be added as part of the integration of semantic routing inference engine 400. The metrics collection module 1410 may comprise monitoring hooks for external tools, as explained below with respect to FIG. 15.

FIG. 15 illustrates a system 1500 for metrics collection by the example metrics collection module 1410 of FIG. 14. And the example metrics collection module 1410 can collect key metrics 1502. In some examples, the key metrics 1502 can include latency 1506, throughput 1508, decision accuracy 1510, and resource usage 1512. Of course, additional key metrics 1502, such as cache hit rates, model inference times, and error rates and types, may be collected by the metrics collection module 1410. The example metrics collection module 1410 may further send the collected metrics to an analysis pipeline 1514 to conduct one or more actions. Example actions performed by the analysis pipeline 1514 may include updating a real time dashboard 1516 and activation of an alert system 1518. Additional actions may include dynamic resource scaling, cache warming/invalidation, and model switching.

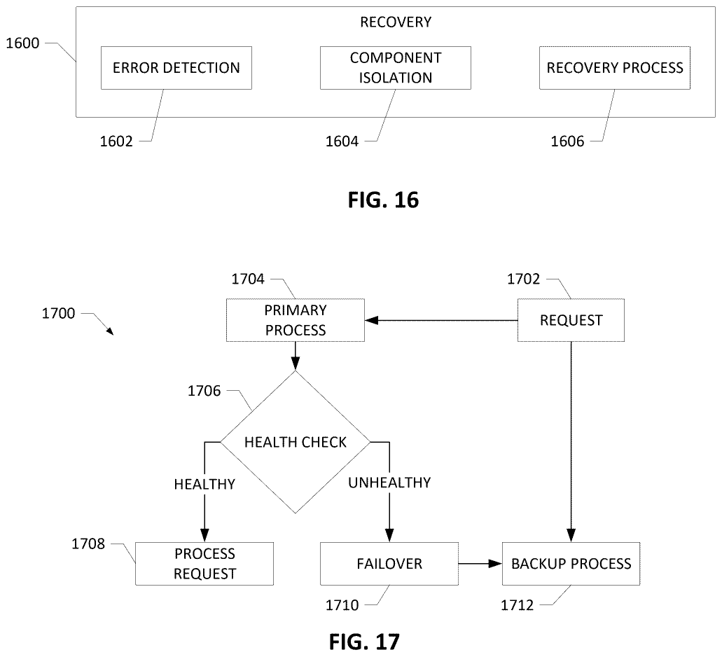

In some examples, the semantic routing inference engine 400 may further comprise fault tolerance, recovery, and backup processes to ensure minimal interruptions. As shown in FIG. 16, the semantic routing inference engine 400 may comprise a recovery module 1600. In some examples, the recovery module 1600 may be part of the core controller 402 described with reference to FIG. 4. The example recovery module 1600 may comprise an error detection module 1602, a component isolation module 1604, and a recovery process module 1606. The error detection module 1602 may perform health checks, detect intrusion and prevent the same, perform security scans, and otherwise monitor and detect errors throughout the system. In some examples upon detection of an error by the error detection module 1602, the component isolation module 1604 may isolate the component associated with the error. In some examples the component isolation module 1604 can implement the circuit breaker mechanisms described herein to isolate the component associated with the error. In some examples, the recovery process module 1606 may attempt to recover an earlier state prior to the component issuing the error. In some examples the recovery process module 1606 may attempt to recover from impacts to the processes described herein without the component issuing the error. In some such examples the recovery process module 1606 may implement automatic failover, state reconciliation, gradual recovery, load shedding, fall back routing strategies, geographic redundancy, recovery procedures from network partitions.

FIG. 17 illustrates an example recovery process 1700 performed by the recovery module 1600 described above with reference to FIG. 16. The process 1700 may begin with a simple request (step 1702). In some examples the request may be sent to a primary process at step 1704. In some examples the primary process may be the process 500 described with reference to FIG. 5, the process 516 described with respect to FIG. 6, the process 700 described with respect to FIG. 7, or another process described herein. As part of the primary process, the error detection module 1602 (FIG. 16) may perform a health check (step 1706). If the error detection module 1602 determines that the primary process 1704 is healthy (step 1706: healthy), then the semantic routing inference engine 400 may process request as described above (step 1708). If the error detection module 1602 determines that the primary process 1704 is unhealthy (step 1706: unhealthy), then the recovery process module 1606 may initiate failover process (step 1710). In some examples, the failover process may initiate a backup process (step 1712). In some examples, the request may be sent to the backup process initially (as part of step 1702) or at the time of failover (step 1710).

Additionally, the semantic routing inference engine 400 may implement comprehensive security measures including encryption of sensitive network topology data, end-to-end encryption of routing data, secure credential management, access control and audit logging, secure key rotation, data backup and recovery procedures, role-based access control for routing decisions, audit trails for regulatory compliance, privacy-preserving routing algorithms, compliance with data protection regulations, and security scanning of routing patterns. Additionally, the semantic routing inference engine 400 may implement privacy preservation measures including data minimization in prompts, anonymous routing patterns, compliance with data protection regulations, privacy-preserving computation techniques, data retention policies, and user consent management.

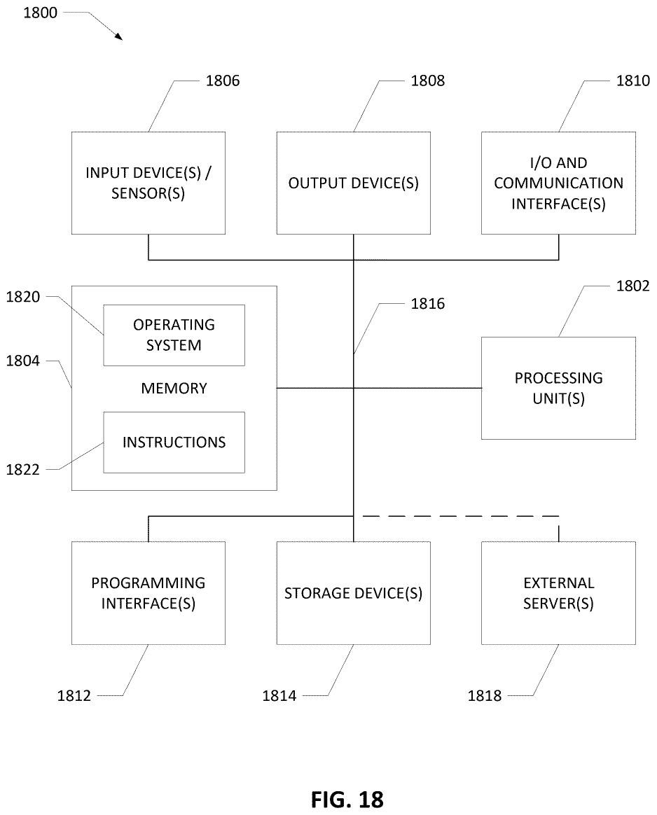

FIG. 18 illustrates an example computing device 1800 that may be used in accordance with the teachings described herein. The example computing device 1800 may be a computer, a tablet, a mobile device, a server, a workstation, an internet-of-things (IoT) device, a smart appliance, a network node, a hub, a router, a modem, or the like. The example computing device 1800 may comprise one or more processing units 1802, one or more memory 1804, one or more input devices or sensors 1806, one or more output devices 1808, one or more input/output (I/O) and communication interfaces 1810, one or more programming interfaces 1812, and one or more storage devices 1814. Each of the one or more processing units 1802, one or more memory 1804, one or more input devices or sensors 1806, one or more output devices 1808, one or more input/output (I/O) and communication interfaces 1810, one or more programming interfaces 1812, and one or more storage devices 1814 may be interconnected via wired connections such as, for example, a bus 1816. Alternatively, each of the one or more processing units 1802, one or more memory 1804, one or more input devices or sensors 1806, one or more output devices 1808, one or more input/output (I/O) and communication interfaces 1810, one or more programming interfaces 1812, and one or more storage devices 1814 may be interconnected wirelessly. In some examples, each of the one or more processing units 1802, one or more memory 1804, one or more input devices or sensors 1806, one or more output devices 1808, one or more input/output (I/O) and communication interfaces 1810, one or more programming interfaces 1812, and one or more storage devices 1814 may be interconnected via a combination of wired and wireless connections. In some examples, the example computing device 1800 may be connected to one or more external servers 1818.

In some examples, the processing unit 1802 may be circuitry or a device configured for processing data. The processing unit 1802 may be a processor such as a central processing unit (CPU), a microprocessor, integrated circuit (IC), an application-specific integrated circuit (ASIC), a Field Programmable Gate Array (FPGA), a graphical processing unit (GPU), a quantum processor, a bioprocessor, a vector processor, a graph processor, or the like. In some examples, the computing device 1800 may have one or more processing units 1802 for parallel processing. In some such examples, the one or more processing units 1802 may be of the same type (e.g., multiple microprocessors). In some examples, the one or more processing units 1802 may be of different types (e.g., at least one CPU and at least one GPU).

In some examples, the memory 1804 may be a non-transitory computer readable storage medium. In some examples, the memory 1804 may include random-access memory, such as DRAM, SRAM, DDR RAM, or other random-access solid-state memory devices. In some examples, the memory 1804 may include an operating system 1820 and instructions 1822.

The operating system 1820 may be a traditional operating system that relies on pre-defined rules and structures such as, for example, Microsoft Windows®, Linux, macOS, etc. The operating system 1820 may be able to function effectively on a wide range of devices and platforms including smartphones, tablets, desktops, servers, etc. In some examples, the operating system 1820 may be decentralized, such that users may share resources and may collaborate without reliance on centralized servers.

The instructions 1822 may comprise computer executable instruction sets for implementing the exemplary processes 500, 516, 700, and 1700 described above with reference to FIGS. 5, 6, 7 and 17.

In some examples, the one or more input devices or sensors 1806 may comprise one or more image/video sensors (e.g., cameras), one or more accelerometers, one or more gyroscopes, one or more thermometers, one or more physiological sensors, one or more microphones, a signal receiver, a haptics engine, a gesture-recognition engine, one or more depth sensors, a keyboard, a numeric pad, a mouse, a touchscreen, a trackpad, or the like.

In some examples, the one or more output devices 1808 may comprise one or more displays, one or more speakers, one or more lights (e.g., light emitting diodes), a signal generator, a haptics engine, a printer, or the like.

In some examples, the one or more I/O and communication interfaces 1810 may comprise USB, FIREWIRE, THUNDERBOLT, WI-FI, IEEE 802.3x, IEEE 802.11x, IEEE 802.16x, GSM, CDMA, TDMA, GPS, IR, BLUETOOTH, ZIGBEE, SPI, 12C, or a similar type of interface.

In some examples, the one or more programming interfaces 1812 may comprise software for implementing one or more physical I/O and communication interfaces, application programming interfaces (APIs) configured for communication with and providing services to databases, software applications, the Internet, or the like.

In some examples, the one or more storage devices 1814 may comprise non-volatile memory, such as one or more magnetic disk storage devices, optical disk storage devices, flash memory devices, or other non-volatile solid-state storage devices. In some examples, the one or more storage devices 1814 may include one or more databases.

In some examples, the one or more external servers 1818 may comprise external processing and storage that may be utilized by the example computing device 1800. In some examples, the one or more external servers 1818 may be configured similarly to the example computing device 1800.

One or more example apparatus, systems, and computer-readable storage mediums are described below.

An example method may comprise, at a first node of a network comprising a plurality of nodes, receiving, from a first device, a query, determining, based on the query, a query signature, comparing the query signature to a plurality of signatures within cache storage, based on the query signature matching one of the plurality of signatures within the cache storage, determining a probability distribution for subsequent nodes of the network, and routing, based on determining a second node associated with a highest probability within the probability distribution for the subsequent nodes, the query to the second node, and based on the query signature not matching one of the plurality of signatures within the cache storage, determining, based on the query and based on a state of the network, contextual information, processing a topology of the network to determine a transformed network structure, determining, based on the query, the contextual information, and the transformed network structure, a third node of the network from the plurality of nodes of the network, and routing the query to the third node of the network.

In some examples, a signature may be generated from the natural language representation of incoming data (where the signature represents a mathematical formula derived from the signal, as described herein), optionally combined with contextual factors, to enable matching against stored probability distributions within cache storage.

An example method may comprise updating, based on routing the query to the second node, the probability distribution for subsequent nodes by increasing a weight associated with the second node.

An example method may comprise updating, based on routing the query to the second node, the probability distribution by decreasing weights associated with the subsequent nodes other than the second node.

An example method may comprise updating, based on routing the query to the third node, the probability distribution for subsequent nodes by increasing a weight associated with the third node.

An example method may comprise updating, based on routing the query to the third node, the probability distribution by decreasing weights associated with the subsequent nodes other than the third node.

In some examples, the probability distribution may comprise weights between zero and one for each of the subsequent nodes of the network, wherein the weights are determined based on routing the query through the network, and alternative routing determinations performed without routing the query through the network, wherein the alternative routing determinations are based on variations of the query, variations of the contextual information, and variations of the transformed network structure.

An example method may comprise, at a first node of a network comprising a plurality of nodes, receiving, from a first device, a query, determining, based on the query and based on a state of the network, contextual information, processing a topology of the network to determine a transformed network structure, determining, based on the query, the contextual information, and the transformed network structure, a second node of the network from the plurality of nodes of the network, determining one or more variations of the query, one or more variations of the contextual information, and one or more variations of the transformed network structure, performing, based on the one or more variations of the query, the one or more variations of the contextual information, and the one or more variations of the transformed network structure, alternative routing determinations, and routing the query to the second node of the network.

In some examples, the determining the second node of the network, the determining one or more variations of the query, the one or more variations of the contextual information, and the one or more variations of the transformed network structure, and the performing alternative routing determinations occur in parallel.

An example method may further comprise creating, based on the determining the second node and based on the alternative routing determinations, a probability distribution for subsequent nodes of the network, and storing, at the first node, the probability distribution in association with a query signature, wherein the query signature is determined based on the query and the one or more variations of the query.

In some examples, the determining the second node of the network comprises generating, based on the query, contextual information, and the transformed network structure, a structured prompt, forwarding the structure prompt to an inference engine, determining, based on a response from the inference engine, the second node of the network.

An example method may comprise based on the routing the query to the second node of the network, increasing a weight associated with second node, and decreasing weights associated with other adjacent subsequent nodes of the network.

In some examples, routing the query to the second node of the network causes a first output.

In some examples, the performing the alternative routing determinations comprises analyzing proposed routes through the network excluding the second node based on the query, the one or more variations of the query, the one or more variations of the contextual information, and the one or more variations of the transformed network structure, determining a first subset of the proposed routes that reach an end node of the network, and determining a second subset of the first subset of the proposed routes for which the end node is associated with a second output having a threshold similarity to the first output.

In some examples, the state of the network comprises network bandwidth and wherein the transformed network structure comprises a third node that was recently added to the network, a first void where a fourth node was recently removed from (or ignored within) the network, a new connection between existing nodes in the network that was recently added, or a second void where a previous connection between existing nodes in the network was recently removed (or blocked/ignored).

An example method comprises, at a first node of a network comprising a plurality of nodes, receiving, from a first device, a query, determining, based on the query and based on a state of the network, contextual information, processing a topology of the network to determine a transformed network structure, determining, based on the query, the contextual information, and the transformed network structure, a second node of the network from the plurality of nodes of the network, and routing the query to the second node of the network.

In some examples, the determining the second node of the network comprises generating, based on the query, contextual information, and the transformed network structure, a structured prompt, forwarding the structure prompt to an inference engine, determining, based on a response from the inference engine, the second node of the network.

An example method comprises, based on the routing the query to the second node of the network, increasing a weight associated with second node, and decreasing weights associated with other adjacent subsequent nodes of the network.

An example method comprises creating, based on the weighting of the plurality of nodes of the network, a probability distribution for subsequent nodes of the network, and storing, in cache, the probability distribution in association with a query signature.

In some examples, the query signature is created based on the query and based on one or more variations of the query.

In some examples, the contextual information comprises media types, timing requirements, query complexity, node functions, network loads, priorities, or historic performance.

An example method comprises determining, based on the query, a query signature, comparing the query signature to a plurality of signatures within cache storage, based on the query signature matching one of the plurality of signatures within the cache storage, determine a probability distribution for subsequent nodes of the network, and routing, based on determining a third node associated with a highest probability within the probability distribution for the subsequent nodes, the query to the third node, and wherein each of the determining the contextual information regarding the state of the network, the processing the topology of the network to determine the transformed network structure, the determining the second node of the network from the plurality of nodes of the network, and the routing the query to the second node of the network are based on the query signature not matching one of the plurality of signatures within the cache storage.

An example apparatus may comprise one or more processors and memory storing instructions that when executed, by the one or more processors, cause performance of any of the above methods.

An example non-tangible computer readable storage medium may store instructions that when executed cause performance of any of the above methods.

An example system may comprise one or more of the above apparatus or computer readable storage medium.

In some examples, an example system may comprise one or more nodes of a network implementing one or more of the above apparatus or computer readable storage medium.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A system comprising:
a network comprising a first node connected to at least two other nodes, wherein the first node is configured to:
receive, from a first device, data;
determine, based on comparing an aspect of the data to metadata associated with the at least two other nodes, a probability distribution indicating routing probabilities for the at least two other nodes;
based on determining that at least one of the at least two other nodes is associated with a routing probability greater than a threshold, route the data to the at least one of the at least two other nodes; and
based on the determining that the at least two other nodes are not associated with probabilities greater than the threshold:
determine, based on the data and based on a state of the network, contextual information;
process a topology of the network to determine a transformed network structure; and
route, based on the data, the contextual information, and the transformed network structure, the data to a first one of the at least two other nodes.

2. The system of claim 1, wherein the first node is further configured to update, based on routing the data to the first one of the at least two other nodes, the probability distribution by increasing a weight associated with the first one of the at least two other nodes.

3. The system of claim 2, wherein the first node is further configured to update, based on routing the data to the first one of the at least two other nodes, the probability distribution by decreasing a weight associated with a second one of the at least two other nodes.

4. The system of claim 1, wherein to route, based on the data, the contextual information, and the transformed network structure, the data to the first one of the at least two other nodes, the first node is further configured to:
prompt an inference engine for a routing determination;
receive, from the inference engine, the routing determination; and
route the data according to the routing determination.

5. The system of claim 4, wherein the first node is further configured to receive, with the routing determination from the inference engine, structured reasoning supporting the routing determination.

6. The system of claim 4, wherein the inference engine is remote from the first node.

7. The system of claim 1, wherein the routing probabilities comprises weights between zero and one for each of the at least two other nodes, wherein the weights are determined based on:
how the data is routed through the network; and
alternative routing determinations performed without routing the data through the network, wherein the alternative routing determinations are based on variations of the data, variations of the contextual information, and variations of the transformed network structure.

8. An apparatus comprising:
one or more processors; and
memory storing instructions that, when executed by the one or more processors, cause the apparatus to:
receive, from a first device, a query;
determine, based on comparing an aspect of the query to metadata associated with at least two nodes of a network, a probability distribution indicating routing probabilities for the at least two nodes;
based on determining that at least one of the at least two nodes is associated with a routing probability greater than a threshold, route the query to the at least one of the at least two nodes; and
based on the determining that the at least two nodes are not associated with probabilities greater than the threshold:
determine, based on the query and based on a state of the network, contextual information;
process a topology of the network to determine a transformed network structure; and
route, based on the query, the contextual information, and the transformed network structure, the query to a first one of the at least two nodes.

9. The apparatus of claim 8, wherein the instructions, when executed, further cause the apparatus to update, based on routing the query to the first one of the at least two nodes, the probability distribution by increasing a weight associated with the first one of the at least two nodes.

10. The apparatus of claim 8, wherein the instructions, when executed, further cause the apparatus to update, based on routing the query to the first one of the at least two nodes, the probability distribution by decreasing a weight associated with a second one of the at least two nodes.

11. The apparatus of claim 8, wherein the instructions, when executed, further cause the apparatus to:
prompt an inference engine for a routing determination;
receive, from the inference engine, the routing determination; and
route the query according to the routing determination.

12. The apparatus of claim 11, wherein the instructions, when executed, further cause the apparatus to receive, with the routing determination from the inference engine, structured reasoning supporting the routing determination.

13. The apparatus of claim 11, wherein the inference engine is remote from the apparatus.

14. The apparatus of claim 8, wherein the routing probabilities comprises weights between zero and one for each of the at least two nodes, wherein the weights are determined based on:
how the query is routed through the network; and
alternative routing determinations performed without routing the query through the network, wherein the alternative routing determinations are based on variations of the query, variations of the contextual information, and variations of the transformed network structure.

15. A method comprising:
at a first node of a network comprising a plurality of nodes:
receiving, from a first device, a query;
determining, based on the query and based on a state of the network, contextual information;
processing a topology of the network to determine a transformed network structure;
determining one or more variations of the query, one or more variations of the contextual information, and one or more variations of the transformed network structure;
determining, based on the one or more variations of the query, the one or more variations of the contextual information, and the one or more variations of the transformed network structure, alternative routing information; and
routing. based on the query, the contextual information, the transformed network structure, and the alternative routing information, the query to a second node of the network.

16. The method of claim 15, wherein the determining, based on the one or more variations of the query, the one or more variations of the contextual information, and the one or more variations of the transformed network structure, the alternative routing information occurs without routing any query through the network.

17. The method of claim 15, further comprising:
generating, based on the query, the contextual information, and the transformed network structure, a structured prompt;
forwarding the structure prompt to an inference engine; and
determining, based on a response from the inference engine, the second node of the network.

18. The method of claim 15, further comprising, based on the routing the query to the second node of the network:
increasing a weight associated with second node; and
decreasing weights associated with other adjacent subsequent nodes of the network.

19. The method of claim 15, wherein routing the query to the second node of the network causes a first output, and wherein the determining the alternative routing information comprises:
analyzing proposed routes through the network excluding the second node based on the query, the one or more variations of the query, the one or more variations of the contextual information, and the one or more variations of the transformed network structure;
determining a first subset of the proposed routes that reach an end node of the network; and
determining a second subset of the first subset of the proposed routes for which the end node is associated with a second output having a threshold similarity to the first output.

20. The method of claim 15, wherein the state of the network comprises network bandwidth and wherein the transformed network structure comprises a third node that was recently added to the network, a first void where a fourth node was recently removed from the network, a new connection between existing nodes in the network that was recently added, or a second void where a previous connection between existing nodes in the network was recently removed.

21. A method comprising:
at a node in a network, during a period when the network has available processing resources:
generating one or more hypothetical queries;
analyzing, without routing any actual data through the network, multiple potential routing paths through the network for the one or more hypothetical queries;
determining, based on the analyzing, probability distributions indicating routing success probabilities for subsequent nodes;
storing the probability distributions in cache storage; and
upon receiving a real query, using the stored probability distributions to make a routing decision for the real query.

22. The method of claim 21, wherein the period when the network has available processing resources comprises a period of low network activity or a period when processing resources exceed a first threshold.

23. The method of claim 21, wherein the analyzing the multiple potential routing paths comprises:
creating variations of each hypothetical query; determining, for each variation, a routing path through the network; evaluating an outcome of each routing path; and assigning weights to subsequent nodes based on the evaluating.

24. The method of claim 21, wherein the storing the probability distributions in cache storage comprises storing the probability distributions in multi-level cache storage, wherein the multi-level cache storage comprises in-memory cache and distributed cache.

25. The method of claim 21, wherein the determining the probability distributions comprises:
determining, for each subsequent node, a natural language representation of capabilities of the subsequent node; comparing natural language representations of the one or more hypothetical queries to the natural language representations of capabilities of the subsequent nodes; and
assigning initial probability scores based on the comparing.

26. The method of claim 21, further comprising:
updating the probability distributions based on actual routing decisions made in response to real queries; and
updating the probability distributions based on additional hypothetical routing analyses performed during subsequent periods when the network has available processing resources.

27. A non-transitory computer-readable storage medium storing instructions that, when executed by one or more processors, cause:
receiving data at a first node of a network; accessing a pre-computed probability distribution for subsequent nodes, wherein the pre-computed probability distribution was generated through hypothetical routing scenarios performed during periods of low network activity;
determining, based on the pre-computed probability distribution, that at least one subsequent node is associated with a routing probability greater than a threshold;
routing the data to the at least one subsequent node; and
updating the pre-computed probability distribution based on routing the data to the at least one subsequent node.

28. The non-transitory computer-readable storage medium of claim 27, wherein the instructions further cause:
based on determining that no subsequent nodes are associated with probabilities greater than the threshold:
determining contextual information based on the data and a state of the network;
processing a topology of the network to determine a transformed network structure;
prompting an inference engine with the data, the contextual information, and the transformed network structure; and
routing the data based on a response from the inference engine.

29. A system comprising:
a topology transformer configured to:
receive a network topology comprising a plurality of nodes and connections between the nodes;
identify subnetworks within the network topology;
generate a transformed network structure that simplifies the network topology by representing groups of nodes as subnetworks;
provide the transformed network structure to an inference engine for routing decisions; and
monitor changes to the network topology and update the transformed network structure accordingly.

30. The system of claim 29, wherein the topology transformer is further configured to:
utilize graph theory algorithms to analyze the network topology;
extract semantic information about capabilities and dependencies of nodes;
identify redundant paths within the network topology; and
create hierarchical subnetworks within subnetworks.

31. A system comprising:
a pattern matcher configured to:
determine natural language representations of incoming data and network nodes;
compare a natural language representation of the incoming data to natural language representations of subsequent nodes of a network;
generate, based on the comparison, a probability distribution indicating routing success probabilities for the subsequent nodes; and
update the probability distribution based on actual routing outcomes and hypothetical routing analyses.

32. The system of claim 31, wherein the pattern matcher is further configured to:
store the probability distribution in cache storage associated with a query signature;
upon receiving new incoming data, determine a query signature for the new incoming data;
compare the query signature to stored query signatures; and
based on matching the query signature to a stored query signature, retrieve a corresponding probability distribution from the cache storage.

33. A method comprising:
for each node in a network, maintaining a probability distribution in cache storage, wherein the probability distribution associates routing success probabilities with each subsequent node connected to the node;
updating the probability distribution in real-time based on:
actual routing paths taken through the network in response to real queries; and
hypothetical routing paths analyzed without routing data through the network during periods of available processing resources; and
using the probability distribution to make routing decisions for subsequently received data.

34. The method of claim 33, wherein the maintaining the probability distribution in cache storage comprises:
storing the probability distribution in a multi-level caching architecture, wherein different cache levels are configured for:
predictive pre-computation of common routes;
cache invalidation based on network topology changes;
distributed caching for geographically dispersed networks; and
partial cache updates for incremental network changes.

35. The method of claim 33, wherein the updating the probability distribution based on hypothetical routing paths comprises:
generating variations of previously received queries;
analyzing routing paths through the network for the variations without actually routing data;
determining outcomes of the analyzed routing paths;
weighting actual routing paths more heavily than hypothetical routing paths; and
storing updated weights in the probability distribution.

36. A method comprising:
receiving data describing capabilities and objectives of a node in a network;
processing the data to extract semantic features of the node;
generating, using a natural language transformer, a natural language representation that describes the capabilities and objectives of the node;
storing the natural language representation in association with the node; and
using the natural language representation for routing decisions by comparing incoming queries to the natural language representation to determine routing probabilities.

37. The method of claim 36, further comprising:
receiving performance data indicating routing outcomes for the node;
updating the natural language representation based on the performance data to reflect actual capabilities and performance characteristics of the node;
determining, based on comparing natural language representations of incoming data with the natural language representation of the node, an initial probability score for routing to the node; and
adjusting the initial probability score based on network state and topology information.
